(19) United States
(12) Patent Application Publication
(10) Pub. No.: US 2012/0309897 A1
(43) Pub. Date: Dec. 6, 2012

(54) Polymers containing heterocyclic 3-ring compounds and iodine-containing compounds

(75) Inventor: Andreas Boettcher, Koln (DE)

(73) Assignee: LANXESS DEUTSCHLAND GMBH, Leverkusen (DE)

(21) Appl. No.: 13/379,055

(22) PCT Filed: Jun. 28, 2010
(86) PCT No.: PCT/EP2010/059113

§ 371 Date: Aug. 9, 2012

(30) Foreign Application Priority Data
Jun. 30, 2009 (EP) 09164218.1

(51) Int. Cl. A01N 47/12; C08K 5/205; C08L 79/04; A01P 1/00; C08G 73/06

(52) U.S. Cl. 524/728; 514/478; 528/332

(57) ABSTRACT

Polymer, comprising at least one heterocyclic 3-membered-ring compound and one iodine-containing compound.

The invention relates to polymers, comprising heterocyclic 3-membered-ring compounds and iodine-containing compounds, to the preparation thereof and to polymer preparations and binder formulations comprising them and to the use thereof for the protection of industrial materials.

Iodine-containing biocides are used for providing industrial materials, coating materials being an example, with protection from infestation, decomposition, destruction and visual alteration by fungi, bacteria and algae, preferentially by fungi. Furthermore, iodine-containing biocides, both alone and in combination with biocides from other classes of active ingredient, are used as components of biocidally active materials protection compositions such as wood preservatives. Besides iodoalkynyl compounds, the active ingredients used here include compounds in which one or more atoms of iodine are attached to double-bond systems, but also to singly bonded carbon atoms.

A behaviour common to many iodine-containing biocides is that on exposure to light even in bulk or as a component of an industrial material (coating material, for example) they lead to yellowing with breakdown of the active compound. This feature hinders or prevents the use of iodine-containing biocides in materials having such sensitivity, such as in light-coloured or white coating materials, for example.

Many iodine-containing biocides, particularly iodoalkynyl compounds, are destroyed with particular rapidity by metal compounds. This fact prevents iodoalkynyl compounds, for example, from being used in solvent-based coating materials, such as paints, varnishes and stains, for example, or in biocidal preservatives, such as wood preservative primers, wood preservative impregnation systems and wood preservative stains, for example, since these alkyd-based coating and preservation systems are regularly equipped with metal compounds. In such systems, transition metal compounds, examples being cobalt, lead, manganese and vanadium octoates, function as dryers (siccatives) for the alkyd resin-containing binder system. Moreover, transition metal compounds are also used as pigments, and in some cases have destructive properties comparable with the siccatives.

In the solvent-based systems referred to above, there are, in addition to the dryers, a series of further ingredients which, to different degrees, lead to breakdown of iodine-containing biocides. Whereas the destabilizing effect is still relatively weak with the solvents that are customarily used, the other customary components of a paint formulation, such as process additives, plasticizers, colour pigments, anti-settling agents, thixotropic agents, corrosion inhibitors, anti-skinning agents and binders, for example, exhibit more or less strongly pronounced destabilizing effects.

As well as in the solvent-based systems described above, problems also attend the use of iodine-containing biocides in certain water-based industrial materials (e.g. coating materials and preservatives such as wood preservative stains and primers). Where the film formation and film hardening of a water-based coating material is based, for example, on the oxidative crosslinking of water-soluble or emulsified alkyd resins, transition metal compounds are employed as siccatives in these systems as well, and their use is accompanied by destruction of the iodine-containing biocides present.

There are already methods known for preventing the degradation of halopropargyl compounds in transition-metal-containing, solvent-based alkyd-resin paints. WO 98/22543, for example, describes the addition of chelating reagents.

Also known are transition-metal-containing, solvent-based alkyd-resin paints where halopropargyl compounds are stabilized by means of organic epoxides (cf. WO 00/16628).

Moreover, there are already descriptions of methods of suppressing the light-induced degradation of active antifungal compounds, such as iodopropargyl butylcarbamate, by addition of tetraalkylpiperidine compounds and/or UV absorbers (cf. EP-A 0083308).

According to WO 2007/028527, iodine-containing biocides are stabilized with 2-(2-hydroxyphenyl)benzotriazoles.

Addition of epoxy compounds is said to reduce the discoloration of iodoalkyne compounds, such as IPBC (cf. U.S. Pat. No. 4,276,211 and U.S. Pat. No. 4,297,258). Epoxides for stabilizing IPBC have also already been described in JP-A-19-120515.

Iodine has been stabilized in JP-A-2006-45686, for example, by means of cyclodextrins (CD), the resulting complex being anchored more effectively on the fibre by polymerization of aziridine-containing monomers. In that case, however, the CD-iodine pairing is only complex, with the iodine or iodophore lying protected in the cavity of the CD, without being bonded covalently to the CD. The iodophore itself, as well, is a complex, in which iodine is not covalently bonded to the support, particularly since this is only a form from which iodine must once more free itself again in order to achieve the desired effect.

Furthermore, there are descriptions of synergistic mixtures of epoxides with UV absorbers (cf. WO 99/29176) and with benzylidene camphor derivatives (cf. U.S. Pat. No. 6,472,424), which likewise exhibit reduced yellowing.

WO 2007/101549, moreover, describes the stabilization of iodine-containing biocides by means of azole compounds.

The stabilizing action of the aforementioned stabilizers, however, is not always sufficient, and carries performance disadvantages. Thus, in particular, the drying times of the paints are markedly prolonged, and in many cases this is unacceptable to the user. Moreover, the inhibition of discoloration is not always sufficient.

Surprisingly, it has now been found that it is possible to provide iodine-containing compounds, preferably iodine-containing biocides in polymers, comprising iodine-containing compounds and heterocyclic 3-membered-ring compounds, particularly aziridines, particularly in solvent-based and water-based systems, with protection against both chemical and light-induced degradation, and hence to prevent the above-described disadvantages of unstabilized iodine-containing compounds, such as alterations to colour and loss of active compound/activity. It has been found, moreover, that using polymers provided in this manner to stabilize iodine-containing biocides in the aforementioned systems engenders no performance disadvantages, such as the prolongation of the drying time of a coating system, for example.

Through the use of polymers comprising heterocyclic 3-membered-ring compounds, more particularly aziridines, the stability of iodine-containing compounds likewise present in the polymer is improved still further. As compared with iodine-containing solutions, even those which already comprise heterocyclic 3-membered-ring compounds, this form possesses, in particular, stability advantages, particularly in storage, preferably at elevated temperatures.

The invention accordingly provides a polymer comprising at least one heterocyclic 3-membered-ring compound and an iodine-containing compound.

The term “comprising” in the context of the heterocyclic 3-membered-ring compound may be taken to mean not only “incorporated in the polymer matrix” but also “attached adsorbtively or covalently to the polymer”. An iodine-containing compound in the context of this invention is an organic compound which possesses at least one covalent iodine-carbon bond.

The proof that a heterocyclic 3-membered-ring compound is “comprised” in the polymer in the manner of the invention is generally furnished by the analytical detection of the heterocyclic 3-membered-ring groups, the aziridine groups for example, by means of suitable methods, an example being solid-state NMR (MAS-NMR). If a heterocyclic 3-membered-ring compound can be detected in the course, for example, of the MAS-NMR determination of the polymer of the invention, this condition is met for the purposes of the present invention.

Heterocyclic 3-membered-ring compounds that are contemplated include preferably those with a 3-membered-ring function which have O, NR, S or Se as a heteroatom in the 3-membered ring, where R is hydrogen or an organic radical. Preferred heterocyclic 3-membered-ring compounds are epoxides or aziridines, more particularly aziridines.

Aziridines contemplated are those which comprise one or more aziridine groups.

Preference is given, for example to aziridine compounds of the formula (I)

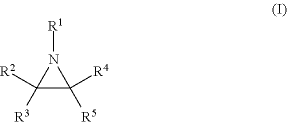

where
R¹ is hydrogen, alkyl or cycloalkyl, each of which are unsubstituted or substituted and/or mono- or polyethylenically unsaturated, or in each case substituted or unsubstituted fullerenyl, aryl, alkoxy, alkoxycarbonyl, arylcarbonyl, alkanoyl, carbamoyl or oxomethylene,
R², R³, R⁴ and R⁵ independently of one another have the same definition as R¹ and additionally independently are halogen, hydroxyl, carboxyl, alkylsulphonyl, arylsulphonyl, nitrile, isonitrile or the radicals
R² and R⁴ or R³ and R⁵, together with the carbon atoms to which they are attached, form a 5- to 10-membered carbocyclic ring which is unsubstituted or substituted and/or mono- or polyethylenically unsaturated.

Monofunctional aziridines of the formula (I) that are contemplated are, for example, those in which R² and R⁴ or R³ and R⁵, together with the carbon atoms to which they are attached, form a 5- to 10-membered carbocyclic ring which is unsubstituted or substituted and/or mono- or polyethylenically unsaturated.

These are, more particularly, those of the formula (II)

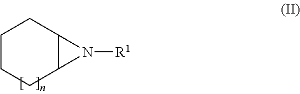

where the carbocyclic ring is unsubstituted or substituted by one or more substituents selected from the group consisting of halogen, hydroxyl, oxo, carboxyl, alkylsulphonyl, arylsulphonyl, nitrile, isonitrile, alkyl or cycloalkyl, each of which is unsubstituted or substituted and/or mono- or polyethylenically unsaturated, or substituted or unsubstituted fullerenyl, aryl, alkoxy, alkoxycarbonyl or alkanoyl, and
n is a number from 0 to 6, preferably 0 to 1.

Likewise preferred are those monofunctional aziridine compounds of the formula (I) in which R¹ is a radical of the formula

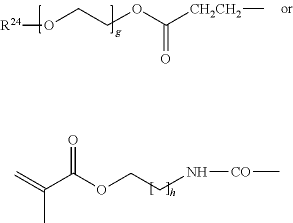

in which
R²⁴ is —H or alkyl, preferably —H, —CH₃, —C₂H₅, more preferably —CH₃, —C₂H₅,
g is a number from 1 to 4, preferably 1 to 3, more preferably 1 to 2,
h is a number from 1 to 11, preferably 1 to 5 and more preferably 1 to 3,
and the remaining radicals have the above definition.

More particular preference is given to those compounds of the formula (I) which conform to the compound of the formula (III) or (IV),

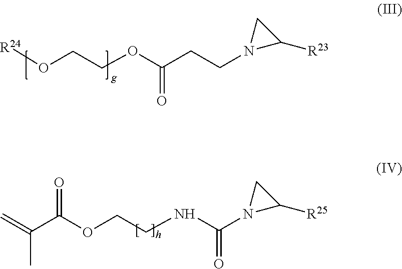

where
R²³ is —H or alkyl, preferably —H or —CH₃, more preferably —CH₃,
R²⁵ is —H or alkyl, preferably —H or —CH₃, more preferably —CH₃, and the remaining radicals have the above definition.

Particularly preferred aziridines are those having two or more aziridine functions. Examples include compounds of the formula (V)

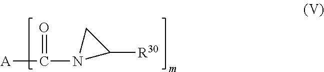

in which
A is an m-valent aliphatic, cycloaliphatic or aromatic radical, which is optionally substituted,
m is a number from 2 to 5, more particularly 2 to 3, and
R³⁰ for each m unit is in each case independently hydrogen or C₁-C₄ alkyl, more particularly CH₃ or CH₂CH₃.

Where m is 2, A is preferably C₂-C₁₀ alkylene,

more particularly
—((CH₂)₆)—, —C(CH₃)₂CH₂C(CH₃)₂CH₂— or
—C(CH₃)₂CH₂CH(CH₃)CH₂—, or
   is a phenylene, more particularly the bivalent radical of the formula

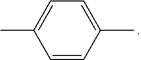

If m is 3, A is preferably the trivalent radical of the formula

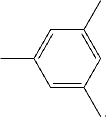

Preferred compounds of the formula (V) are those conforming to the formulae (Va)-(Vd).

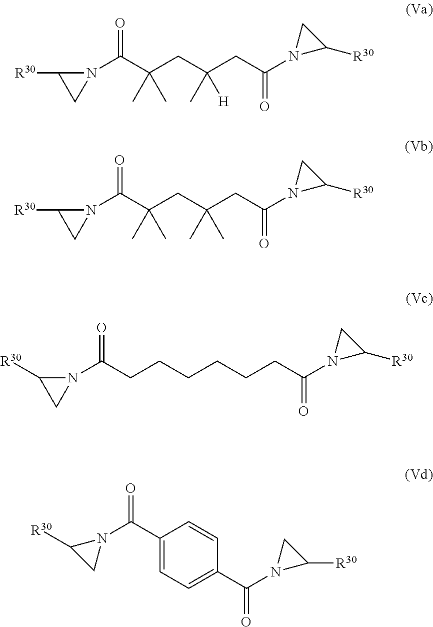

Likewise preferred as polyfunctional aziridine compounds are Michael adducts of optionally substituted ethylenimine with esters of polyhydric alcohols with α,β-unsaturated carboxylic acids and the adducts of optionally substituted ethylenimine with polyisocyanates.

Suitable alcohol components are, for example, trimethylolpropane, neopentylglycol, glycerol, pentaerythritol, 4,4′-isopropylidenediphenol, 4,4′-methylenediphenol and polyvinyl alcohols. Examples of suitable α,β-unsaturated carboxylic acids include acrylic acid and methacrylic acid, crotonic acid and cinnamic acid. Particular preference is given to acrylic acid. The corresponding polyhydric alcohols of the α,β-unsaturated carboxylic esters may optionally be alcohols which have been extended on their OH functions in some cases completely with alkylene oxides, singly or multiply. These may be, for example, the aforementioned alcohols extended singly or multiply with alkylene oxides. In this respect, reference is also made to U.S. Pat. No. 4,605,698, the disclosure content of which is included by reference in the present invention. Alkylene oxides which are particularly suitable in accordance with the invention are ethylene oxide and propylene oxide.

Examples of polyisocyanates suitable for reaction with optionally substituted ethylenimine are those specified at page 4 lines 33-35 of WO 2004/050617.

Examples of aziridines that are suitable in accordance with the invention are those specified at page 3 lines 29-34 of WO 2004/050617.

Preference is likewise given to those aziridines of the kind described, for example, in U.S. Pat. No. 3,225,013 (Fram), U.S. Pat. No. 4,490,505 (Pendergrass) and U.S. Pat. No. 5,534,391 (Wang).

Likewise preferred are those aziridines of the formula (I) which possess at least three aziridine groups, such as, for example, trimethylolpropane tris[3-(1-aziridinyl)propionate], trimethylolpropane tris[3-(2-methyl-1-aziridinyl)propionate], trimethylolpropane tris[2-aziridinylbutyrate], tris(1-aziridinyl)phosphine oxide, tris(2-methyl-1-aziridinyl)phosphine oxide, pentaerythritol tris[3-(1-aziridinyl)propionate] and pentaerythritol tetrakis-[3-(1-aziridinyl)propionate].

Of these, preference is given particularly to trimethylolpropane tris[3-(1-aziridinyl)propionate], trimethylolpropane tris[3-(2-methyl-1-aziridinyl)propionate], trimethylolpropane tris[2-aziridinylbutyrate], pentaerythritol tris[3-(1-aziridinyl)propionate] and pentaerythritol tetrakis-[3-(1-aziridinyl)propionate].

Particularly preferred are trimethylolpropane tris[3-(1-aziridinyl)propionate], trimethylolpropane tris[3-(2-methyl-1-aziridinyl)propionate] and pentaerythritol tetrakis-[3-(1-aziridinyl)propionate].

Likewise preferred are polyfunctional aziridines of the formula (VI)

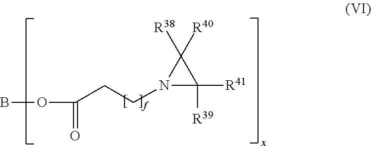

in which
B is the radical of an aliphatic polyol which contains at least x OH functions, where x OH functions are substituted by the radical of the above brackets,
f is a number from 0 to 6, more particularly from 1 to 3,
x is a number greater than or equal to 2, and more particularly is 2 to 500 000, and
R³⁸, R³⁹, R⁴⁰ and R⁴¹ have the identical meaning as the radicals R²-R⁵ in the formula (I).

Particularly preferred aziridines of the formula (VI) are those in which x is 3 or 4 and B is a trebly or quadruply OH-functional polyol.

Particularly preferred aziridines of the formula (VI) are those conforming to the formulae (VIa)-(VIc)

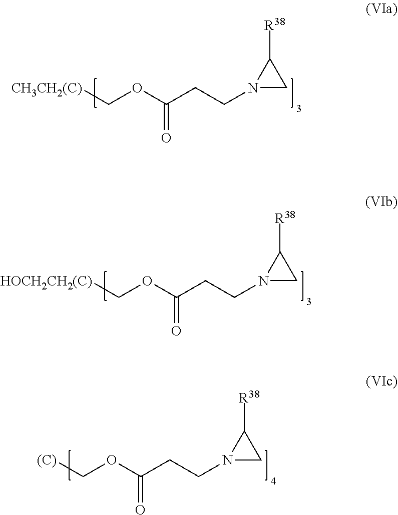

in which
R³⁸ is hydrogen or CH₃.

A particularly preferred product is the aziridine compound of the formula (VIa), with R³⁸=methyl, also known as Crosslinker CX-100 from DSM, and the hardener product “Corial Härter AN” from BASF, which comprises the aziridine of the formula (VIa) with R³⁸=hydrogen.

Epoxides contemplated include all compounds which comprise one or more oxirane rings.

Preference is given, for example, to epoxides of the general formula (VII):

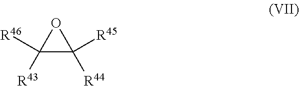

in which
R⁴³, R⁴⁴, R⁴⁵ and R⁴⁶ independently of one another are hydrogen, alkyl or cycloalkyl, each of which is unsubstituted or substituted and/or mono- or polyethylenically unsaturated, or in each case substituted or unsubstituted fullerenyl, aryl, alkoxy, aryloxy, alkanoyl, alkoxycarbonyl, arylcarbonyl, alkanoyl, carbamoyl or oxomethylene, halogen, hydroxyl, carboxyl, alkylsulphonyl, arylsulphonyl, nitrile or isonitrile
or the radicals
R⁴³ and R⁴⁴ or R⁴⁵ and R⁴⁶, together with the carbon atoms to which they are attached, form a 5- to 10-membered carbocyclic ring which is unsubstituted or substituted and/or mono- or polyethylenically unsaturated.

Preferred “alkyl” is a linear or branched alkyl radical having 1 to 20, preferably 1 to 12, carbon atoms. Examples of alkyl radicals according to the invention are methyl, ethyl, n-propyl, isopropyl, n-butyl, isobutyl, sec-butyl, tert-butyl, pentyl, iso-amyl, hexyl, octyl, etc. The aforementioned alkyl radicals may preferably be substituted by the following radicals: alkoxy, preferably C₁-C₁₂ alkoxy, nitro, monoalkylamino, preferably C₁-C₁₂ monoalkylamino, dialkylamino, preferably di[C₁-C₁₂] alkylamino, cyano, halo, haloalkyl, preferably trifluoromethyl, alkanoyl, aminocarbonyl, monoalkylaminocarbonyl, dialkylaminocarbonyl, alkylamido, preferably C₁-C₁₂ alkylamido, alkoxycarbonyl, preferably C₁-C₁₂ alkoxycarbonyl, alkylcarbonyloxy, preferably C₁-C₁₂ alkylcarbonyloxy, aryl, preferably phenyl, or aryl substituted by halogen, C₁-C₁₂ alkyl or C₁-C₁₂ alkoxy, or heterocyclic 3-membered-ring groups, more particularly aziridine groups or epoxy groups, or substituents, such as those specified above, which contain these groups.

The radicals R⁴³, R⁴⁴, R⁴⁵ and R⁴⁶ are preferably, in each case independently, hydrogen or aralkyl, aryloxyalkyl, alkoxyalkyl such as epoxydialkoxyalkyl, e.g. 2,3-epoxy-1-propoxyethoxymethyl, 2,3-epoxy-1-butoxyethoxyethyl or 3,4-epoxy-1-butoxyethoxyethyl, or are the radical of the formula

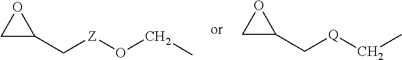

where
Z is unbranched or branched C₁-C₁₀ alkylene, more particularly propylene, butylene, pentylene, hexylene, or heptylenes, halogenated unbranched or branched C₁-C₁₀ alkylene such as, for example, 2,2-dichloromethylpropylene
and
   Q is C₁-C₄ alkylene, carbonylarylcarboxyl such as, for example, carbonylphenylcarboxyl.

The preferred epoxides include the compounds in which
R⁴⁶ is hydrogen, alkoxy, alkyl or 2,3-epoxy-1-propoxyethoxymethyl,
R⁴³ is hydrogen or alkyl and
R⁴⁴ and R⁴⁵ are hydrogen,
   and additionally R⁴³ and R⁴⁴ or R⁴⁵ and R⁴⁶, together with the carbon atoms to which they are attached, form a 5- to 10-membered carbocyclic ring which is unsubstituted or substituted and/or mono- or polyethylenically unsaturated.

The particularly preferred epoxides include glycidyl ethers. These compounds are characterized in that they comprise one or more 2,3-epoxypropanoxy groups and may be represented by the general formula (VIII):

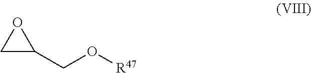

where
R⁴⁷ has the same definition as R⁴³, R⁴⁴, R⁴⁵ or R⁴⁶.

Many of these glycidyl ethers are obtainable commercially. Suitability is possessed in principle by all glycidyl ethers, more particularly those preparable by reacting 1-chloro-2,3-epoxypropane with alcohols, or by reacting glycidyl alcohol with suitable electrophiles, examples being halides.

Also particularly preferred are epoxide-containing products obtainable by reacting epichlorohydrin (1-chloro-2,3-epoxypropane) with polyhydric alcohols, more particularly polyhydric phenols such as, for example, bisphenol A, including oligomeric and polymeric reaction products. Particularly preferred are those having an average molar weight of less than 2000 g/mol, more particularly less than 1000 g/mol.

The preferred epoxides also include the following compounds:

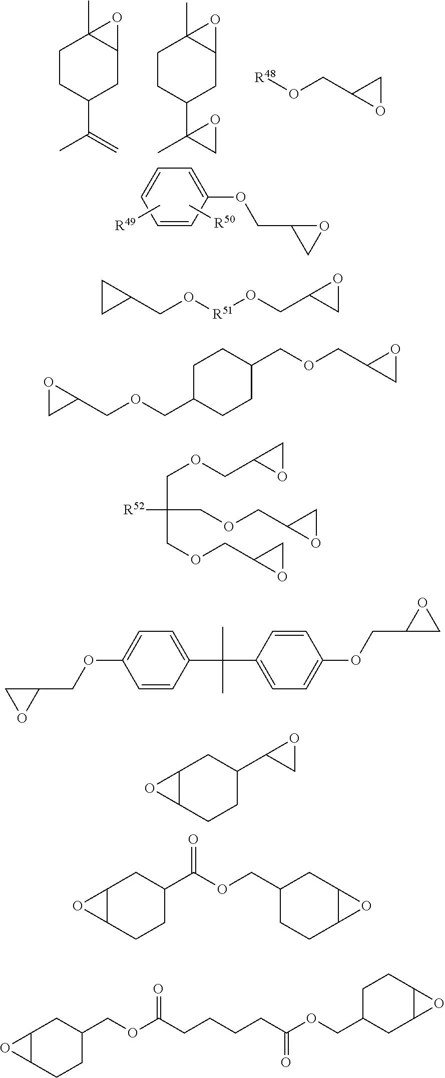

where
R⁴⁸ is C₁-C₂₀ alkyl
R⁴⁹ is H, alkyl or substituted alkyl,
R⁵⁰ is halogen,
R⁵¹ is C₁-C₂₀ alkyl and
R⁵² is H, C₁-C₂₀ alkyl, preferably methyl or ethyl.

Iodine-containing compounds contemplated are preferably iodoalkynyl compounds or compounds in which one or more iodine atoms are attached to double bonds or in which one or more iodine atoms are attached to singly bonded carbon atoms.

The iodine-containing compounds, more particularly biocides, are, for example, diiodomethyl p-tolyl sulphone, diiodomethyl p-chlorophenyl sulphone, 3-bromo-2,3-diiodo-2-propenyl alcohol, 2,3,3-triiodoallyl alcohol, 4-chloro-2-(2-chloro-2-methylpropyl)-5-[(6-iodo-3-pyridinyl)methoxy]-3(2H)-pyridazinone (CAS RN: 120955-77-3), iodofenfos, 3-iodo-2-propynyl 2,4,5-trichlorophenyl ether, 3-iodo-2-propynyl 4-chlorophenyl formal (IPCF), N-iodopropargyloxycarbonylalanine, N-iodopropargyloxycarbonylalanine ethyl ester, 3-(3-iodopropargyl)benzoxazol-2-one, 3-(3-iodopropargyl)-6-chlorobenzoxazol-2-one, 3-iodo-2-propynyl alcohol, 4-chlorophenyl 3-iodopropargyl formal, 3-iodo-2-propynyl propylcarbamate, 3-iodo-2-propynyl butylcarbamate (IPBC), 3-iodo-2-propynyl m-chlorophenylcarbamate, 3-iodo-2-propynyl phenylcarbamate, di(3-iodo-2-propynyl) hexyldicarbamate, 3-iodo-2-propynyloxyethanol ethylcarbamate, 3-iodo-2-propynyloxyethanol phenylcarbamate, 3-iodo-2-propynyl thioxothioethylcarbamate, 3-iodo-2-propynyl carbamate (IPC), 3-bromo-2,3-diiodo-2-propenyl ethylcarbamate, 3-iodo-2-propynyl n-hexylcarbamate or 3-iodo-2-propynyl cyclohexylcarbamate.

The iodine-containing compounds, more particularly biocides, are preferably 3-iodo-2-propynyl 2,4,5-trichlorophenyl ether, 3-iodo-2-propynyl 4-chlorophenyl formal (IPCF), N-iodopropargyloxycarbonylalanine, N-iodopropargyloxycarbonylalanine ethyl ester, 3-(3-iodopropargyl)benzoxazol-2-one, 3-(3-iodopropargyl)-6-chlorobenzoxazol-2-one, 3-iodo-2-propynyl alcohol, 4-chlorophenyl 3-iodopropargyl formal, 3-iodo-2-propynyl propylcarbamate, 3-iodo-2-propynyl butylcarbamate (IPBC), 3-iodo-2-propynyl m-chlorophenylcarbamate, 3-iodo-2-propynyl phenylcarbamate, di(3-iodo-2-propynyl)hexyldicarbamate, 3-iodo-2-propynyloxyethanol ethylcarbamate, 3-iodo-2-propynyloxyethanol phenylcarbamate, 3-iodo-2-propynyl thioxothioethylcarbamate, 3-iodo-2-propynyl carbamate (IPC), 3-bromo-2,3-diiodo-2-propenyl ethylcarbamate, 3-iodo-2-propynyl n-hexylcarbamate or 3-iodo-2-propynyl cyclohexylcarbamate.

With particular preference the iodine-containing compounds, more particularly biocides, are 3-iodo-2-propynyl propylcarbamate, 3-iodo-2-propynyl butylcarbamate (IPBC), 3-iodo-2-propynyl m-chlorophenylcarbamate, 3-iodo-2-propynyl phenylcarbamate, di(3-iodo-2-propynyl) hexyldicarbamate, 3-iodo-2-propynyloxyethanol ethylcarbamate, 3-iodo-2-propynyloxyethanol phenylcarbamate, 3-iodo-2-propynyl thioxothioethylcarbamate, 3-iodo-2-propynyl carbamate (IPC), 3-bromo-2,3-diiodo-2-propenyl ethylcarbamate, 3-iodo-2-propynyl n-hexylcarbamate or 3-iodo-2-propynyl cyclohexylcarbamate.

Furthermore, the particularly preferred iodine-containing compounds, more particularly biocides, are N-alkyl-iodotetrazoles, N-aryl-iodotetrazoles and N-aralkyl-iodotetrazoles, as described, for example, in (EP1773125).

The iodine-containing compounds, more particularly biocides, may be used individually or in mixtures together with two or more iodine-containing compounds, more particularly biocides. Particular preference is given to IPBC.

Preferred polymers are natural polymers, examples being cellulose, proteins, polyprenes or lignin, semi-synthetic polymers such as, for example, cellulose acetate, cellulose ethers, cellulose nitrate, crosslinked casein or carboxymethylcellulose and/or synthetic polymers, more particularly those based on ethylenically unsaturated monomers such as, for example, polyvinyl chloride, polyethylene (HDPE, LDPE, VLDPE), polypropylene, polystyrene, modified polystyrenes such as SAN, ABS, polyacrylates or copolymers thereof, polyesters such as, for example, polyethylene terephthalate, polybutylene terephthalate or unsaturated polyester resins, and also polyurethanes, polyamides, polyureas, polycarbonates, polyalkylene glycols, polyimides, polyamines, alkyd resins, phenolic resins, amino resins or epoxy resins. The stated polymers may also be employed in the form of blends or, where possible, in the form of copolymers as well.

Particularly preferred are polymers based on ethylenically unsaturated monomers. Preference is given to a polymer characterized in that the polymer is constructed of ethylenically unsaturated monomers M comprising:
at least 30% by weight, more particularly at least 40% by weight, very preferably at least 50% by weight, based on the total amount of the monomers M, of at least one neutral, monoethylenically unsaturated monomer M¹ having a water solubility of not more than 50 g/l at 25° C., preferably not more than 30 g/l at 25° C.,
up to 60% by weight, more particularly from 0.01 to 50% by weight, based on the total amount of the monomers M, of one or more polyethylenically unsaturated monomers M², different from the monomers M¹, and
up to 40% by weight, more particularly up to 0.01% to 40% by weight, based on the total amount of the monomers M, of one or more monomers M³ which are different from the monomers and M² and are charge-carrying or potentially charge-carrying or neutral and preferably not potentially charge-carrying, having a water solubility of more than 50 g/l at 25° C.

Particularly preferred are polymers where fractions of the monomers M¹, M² and M³ used amount to 100%.

Particularly preferred is a polymer constructed of ethylenically unsaturated monomers M wherein the monomers M are at least one monomer M³ in an amount of 0.01% to 40% by weight, more particularly 0.1% to 30% by weight, based on the total amount of the monomers M, which is selected from
monoethylenically unsaturated monomers M^{3a} which contain at least one anionic group,
monoethylenically unsaturated, neutral monomers M^{3b}, which have a water solubility of at least 50 g/l at 25° C., and
monoethylenically unsaturated monomers M^{3c}, which contain at least one cationic group and/or at least one group which is protonatable in an aqueous environment.
The monomers M preferably comprise at least one monomer M^{3a}.

The polymer of the invention is preferably constructed to an extent of at least 30% by weight, based on the total amount of the monomers M fanning the polymer, preferably to an extent of 40% to 99.5% by weight and more preferably 50% to 98% by weight, of neutral, monoethylenically unsaturated monomers M¹ having a water solubility of not more than 30 g/l at 25° C., more particularly at 1013 mbar. The water solubility of the monomers M¹ under these conditions is more particularly not more than 20 g/l. Suitable monomers M¹ encompass vinylaromatic monomers such as styrene, esters of monoethylenically unsaturated monocarboxylic and dicarboxylic acids having 3 to 8 and more particularly 3 or 4 C atoms with C₁-C₂₀ alkanols or with C₅-C₈ cycloalkanols, more particularly the esters of acrylic acid, of methacrylic acid, of crotonic acid, the diesters of maleic acid, of fumaric acid and of itaconic acid, and more preferably the esters of acrylic acid with C₁-C₁₈ alkanols (=C₁-C₁₈ alkyl acrylates) such as ethyl acrylate, n-butyl acrylate, isobutyl acrylate, tert-butyl acrylate, n-hexyl acrylate, 2-ethylhexyl acrylate, 3-propylheptyl acrylate and stearyl acrylate, and also the esters of methacrylic acid with C₁-C₁₈ alkanols such as methyl methacrylate, ethyl methacrylate, n-butyl methacrylate, isobutyl methacrylate, tert-butyl methacrylate, n-hexyl methacrylate, stearyl methacrylate and the like.

Suitable monomers M¹ are, furthermore, vinyl esters and allyl esters of aliphatic carboxylic acids having 1 to 20 C atoms, examples being vinyl acetate, vinyl propionate and also the vinyl esters of Versatic® acids (vinyl versatates), vinyl halides such as vinyl chloride and vinylidene chloride, conjugated diolefins such as butadiene and isoprene, and also C₂-C₆ olefins such as ethylene, propylene, 1-butene and n-hexene. Preferred monomers M¹ are vinylaromatic monomers, more particularly styrene, C₁-C₂₀ alkyl acrylates, more particularly C₁-C₁₈ alkyl acrylates and C₁-C₁₈ alkyl methacrylates.

Preferred ethylenically unsaturated monomers M further comprise 0.1% to 60% by weight, more particularly 0.5% to 50% by weight, of at least one ethylenically polyunsaturated monomer M².

The monomers M² include, in particular, divinylbenzene, acrylates and methacrylates of dihydric and polyhydric alcohols such as, for example, butanediol, pentaerythritol and glycerol.

Preferred ethylenically unsaturated monomers M are, furthermore, at least 0.01% to 40% by weight, in particular 0.1% to 30% by weight, of at least one ethylenically unsaturated monomer M³ different from the monomers M¹ and M².

The monomers M³ include, in particular, monoethylenically unsaturated monomers M^{3a}, which contain at least one anionic group, more particularly monomers M^{3a} which contain at least one acid group, preferably at least one sulphonic acid group, one phosphonic acid group or one or two carboxylic acid groups, and also the salts of the monomers M^{3a}, more particularly the alkali metal salts, examples being the sodium or potassium salts, and also the ammonium salts. Included here are ethylenically unsaturated sulphonic acids, more particularly vinylsulphonic acid, 2-acrylamido-2-methylpropanesulphonic acid, 2-acryloyloxyethanesulphonic acid and 2-methacryloyloxyethanesulphonic acid, 3-acryloyloxy- and 3-methacryloyloxypropanesulphonic acid, vinylbenzenesulphonic acid and the salts thereof, ethylenically unsaturated phosphonic acids, such as vinylphosphonic acid and dimethyl vinylphosphonate and the salts thereof, and α,β-ethylenically unsaturated C₃-C₈ monocarboxylic and C₄-C₈ dicarboxylic acids, more particularly acrylic acid, methacrylic acid, crotonic acid, maleic acid, fumaric acid and itaconic acid. The fraction of the monomers M^{3a} is preferably not greater than 35% by weight, preferably not greater than 20% by weight, e.g. 0.1% to 20% by weight and more particularly 0.5% to 15% by weight, based on the total amount of the monomers M.

The monomers M³ further include the monoethylenically unsaturated, neutral monomers M^{3b}, which have a water solubility of at least 50 g/1 at 25° C., more particularly at least 100 g/l at 25° C. Examples thereof are the amides of the aforementioned ethylenically unsaturated carboxylic acids, more particularly acrylamide and methacrylamide, ethylenically unsaturated nitriles such as methacrylonitrile and acrylonitrile, hydroxyalkyl esters of the aforementioned α,β-ethylenically unsaturated C₃-C₈ monocarboxylic acids and of the C₄-C₈ dicarboxylic acids, especially hydroxyethyl acrylate, hydroxyethyl methacrylate, 2- and 3-hydroxypropyl acrylate, 2- and 3-hydroxypropyl methacrylate, esters of the aforementioned monoethylenically unsaturated monocarboxylic and dicarboxylic acids with C₂-C₄ polyalkylene glycols, especially the esters of these carboxylic acids with polyethylene glycol or alkyl-polyethylene glycols, in which case the (alkyl)polyethylene glycol radical typically has a molecular weight in the range from 100 to 3000 g mol⁻¹. The monomers M^{3b} further include N-vinyl amides such as N-vinylformamide, N-vinylpyrrolidone, N-vinylimidazole and N-vinylcaprolactam. The fraction of the monomers M^{3b} is preferably not more than 20% by weight, and in particular not more than 10% by weight, e.g. 0.1% to 10% and more particularly 0.5% to 5% by weight, based on the total amount of the monomers M.

The monomers M³ further include monoethylenically unsaturated monomers M^{3c}, which contain at least one cationic group and/or at least one group which can be protonated in an aqueous environment. The monomers M^{3c} include more particularly those which contain a protonatable amino group, a quaternary ammonium group, a protonatable imino group or a quaternized imino group. Examples of monomers with a protonatable imino group are N-vinylimidazole and vinyl-pyridines. Examples of monomers with a quaternized imino group are N-alkylvinylpyridinium salts and N-alkyl-N′-vinylimidazolinium salts such as N-methyl-N′-vinylimidazolinium chloride or methosulphate. Among the monomers M^{3c}, preference is given more particularly to the monomers of the general formula (IX)

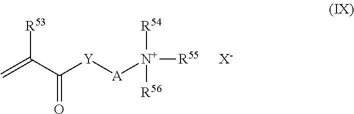

where
R⁵³ is hydrogen or C₁-C₄ alkyl, more particularly hydrogen or methyl,
R⁵⁴ and R⁵⁵ independently of one another are C₁-C₄ alkyl, more particularly methyl,
R⁵⁶ is hydrogen or C₁-C₄ alkyl, more particularly hydrogen or methyl,
Y is oxygen, NH or NR⁵⁷ with R⁵⁷=C₁-C₄ alkyl,
A is C₂-C₈ alkylene, e.g. 1,2-ethanediyl, 1,2- or 1,3-propanediyl, 1,4-butanediyl or 2-methyl-1,2-propanediyl, optionally interrupted by 1, 2 or 3 non-adjacent oxygen atoms,
X is an anionic equivalent, e.g. Cl⁻, HSO₄⁻, ½SO₄²⁻ or CH₃OSO₃⁻ etc.

Examples of monomers of the formula (IX) are 2-(N,N-dimethylamino)ethyl acrylate, 2-(N,N-dimethylamino)ethyl methacrylate, 2-(N,N-dimethylamino)ethylacrylamide, 3-(N,N-dimethylamino)propylacrylamide, 3-(N,N-dimethylamino)propylmethacrylamide, 2-(N,N-dimethylamino)ethylmethacrylamide, 2-(N,N,N-trimethylammonio)ethyl acrylate chloride, 2-(N,N,N-trimethylammonio)ethyl methacrylate chloride, 2-(N,N,N-trimethylammonio)ethylmethacrylamide chloride, 3-(N,N,N-trimethylammonio)propylacrylamide chloride, 3-(N,N,N-trimethylammonio)propylmethacrylamide chloride, 2-(N,N,N-trimethylammonio)ethylacrylamide chloride, and also the corresponding methosulphates and sulphates.

In one preferred embodiment, the monomers M which form the polymer comprise at least one monomer M^{3a}. The fraction of the monomers M^{3a} is in that case advantageously 0.1% to 20% by weight, more particularly 0.5% to 10% by weight, and very preferably 1% to 7% by weight, based on the total amount of the monomers M.

In one particularly preferred embodiment of the invention, the polymer has an anionic net charge, i.e. the molar fraction of the monomers M^{3a} exceeds the molar fraction of the monomers M^{3c} in the polymer and amounts preferably to 110 mol %, more particularly at least 120 mol % and very preferably at least 150 mol %, based on the monomers M^{3c}, or the monomers M which comprise the polymer comprise no cationic or potentially cationic monomer M^{3c}.

The monomers M² and M³, which are not explicitly stated here, further include all of the monomers meeting the definition that can typically be employed in an emulsion polymerization.

The polymer is constructed preferably of 50% to 98% by weight of monomer M¹, 0.5% to 50% by weight of monomer M² and 0.1% to 30% by weight of monomer M^{3a}. With particular preference, of 50% to 98% by weight of methyl methacrylate and stearyl methacrylate, 0.5% to 50% by weight of divinylbenzene and 0.1% to 30% by weight of sodium 4-vinylbenzenesulphonate.

The polymers of the invention are preferably in the form of particulate particles, in particular having an average particle size of less than 15 μm, in particular less than 10 μm, preferably less than 6 μm, the average particle size being measured by dynamic light scattering. Methods for this are found for example in WO2005/102044 page 4, lines 24-32. For application in paints, especially topcoats, preferably film-forming topcoats with film thicknesses of >10 μm, the average particle size is preferably less than 10 μm. For penetrating systems, more particularly stains, it is preferred to use average particle sizes of less than 1 μm.

The polymers of the invention may in addition also comprise, furthermore, one or more ingredients such as emulsifiers, stabilizers, examples being antioxidants, free-radical scavengers, UV stabilizers such as UV absorbers, chelators, and also further biocides (for examples, see below).

The polymer of the invention comprises preferably

0.001% to 80% by weight, preferably 0.005% to 60% by weight, more particularly 0.01% to 50% by weight, more preferably 0.01%-30% by weight, likewise preferably 5% to 80% by weight, particularly 10% to 70% by weight, and more particularly 20% to 60% by weight, of at least one heterocyclic 3-membered-ring compound, more particularly an aziridine compound, and
0.001% to 80% by weight, preferably 0.005% to 60% by weight, more particularly 0.01% to 50% by weight, likewise preferably 5% to 80% by weight, particularly 10% to 70% by weight, and more particularly 20% to 60% by weight, of at least one iodine-containing biocide.

Particularly preferred polymers of the invention comprise at least one aziridine of the formula (VI) and IPBC.

The polymer of the invention preferably comprises the iodine-containing biocide and an aziridine compound in total at from 1% to 80% by weight, preferably 10% to 80% by weight, particularly 20% to 70% by weight, and more particularly 25% to 60% by weight.

In the context of the inventive use, the amount of all of the heterocyclic 3-membered-ring compounds, more particularly aziridines, present in the polymer of the invention is generally 1% to 280% by weight, preferably 2% to 225% by weight, more particularly 5% to 110% by weight, based on the iodine-containing compound.

It is preferred, based on the iodine-containing compound, to use 0.05 to 5, preferably 0.1 to 4, more particularly 0.25 to 2 equivalents of the heterocyclic 3-membered-ring functions, more particularly aziridine functions, that are present in the total of all the heterocyclic 3-membered-ring compounds.

The invention further provides a process for preparing the polymer of the invention, this process being characterized in that
a) at least one iodine-containing compound, at least one heterocyclic 3-membered-ring compound and a polymer are mixed in the presence of at least one solvent and then the solvent is removed, or
b) at least one polymer, preferably a thermoplastic polymer, at least one iodine-containing compound and at least one heterocyclic 3-membered-ring compound are extruded, optionally with use of further auxiliaries, or
c) an aqueous dispersion of a preferably finely divided polymer, in the presence of an O/W emulsion, comprising at least one iodine-containing compound, at least one heterocyclic 3-membered-ring compound, water and organic solvent, is sheared, preferably by means of a paddle blade stirrer or a bead mill, or
d) an aqueous dispersion of a preferably finely divided polymer comprising at least one iodine-containing compound, in the presence of an O/W emulsion, comprising at least one heterocyclic 3-membered-ring compound, water and organic solvent, is sheared, preferably by means of a paddle blade stirrer or a bead mill, or
e) an aqueous dispersion of a preferably finely divided polymer, comprising at least one heterocyclic 3-membered-ring compound, in the presence of an O/W emulsion, comprising at least one iodine-containing compound, water and organic solvent, is sheared, preferably by means of a paddle blade stirrer or a bead mill, or
f) the polymer is prepared in the presence of at least one iodine-containing compound and at least one heterocyclic 3-membered-ring compound, preferably by emulsion polymerization of ethylenically unsaturated monomers.

For alternative a), a preferred solvent is one in which the iodine-containing compound and the 3-membered-ring compound are each soluble to an extent of at least 20 g/l at 25° C., and which is suitable for dissolving or swelling the polymer used. The polymer and the heterocyclic 3-membered-ring compound may also optionally already be present in suitable, different solvents before they are mixed. Preferred solvents, accordingly, are typical solvents for polymers, described for example in K.-F. Egert, “Plastics, Analysis” in Ullmann's Encyclopedia of Industrial Chemistry, online edition, published on 15 Jun. 2000 and also aromatics, such as xylene, toluene or alkylnaphthalenes, heteroaromatics such as pyridine or pyrrole, chlorinated aromatics or chlorinated aliphatic hydrocarbons, such as chlorobenzenes, chloroethylenes or methylene chloride, aliphatic hydrocarbons, such as cyclohexane or paraffins, e.g. petroleum fractions (white spirit, Shellsol D60 from Shell Chemical), alcohols, ethers and esters of alcohols such as, for example, Texanol from Eastman, butanol or glycol, ketones, such as acetone, methyl ethyl ketone, methyl isobutyl ketone or cyclohexanone, cyclic ethers such as tetrahydrofuran, especially strongly polar aprotic solvents, such as dimethylformamide, dimethyl sulphoxide or N-methyl-2-pyrrolidone, and also, for example, etherified glycols, oligoglycols and polyglycols, etherified polyols and esterified polyols, esters of monobasic and of polybasic carboxylic acids, e.g. diisobutyl adipate and diisobutyl maleate (e.g. Rhodiasolv® DIB), and also mixtures thereof. The polymer, preferably a polymer based on ethylenically unsaturated monomers, is preferably partially dissolved or swollen in this process, thereby allowing the additives to migrate into the polymer.

In the case of alternative b), at least one iodine-containing compound and/or at least one heterocyclic 3-membered-ring compound can also be added in a compounded form or in the form of a masterbatch to the polymer. In this case, said compounded form comprises, in addition to the polymer, at least one of the stated iodine and/or 3-membered-ring compounds, more particularly in a fraction of up to 70% by weight. In the case of extrusion according to alternative b), it is preferred to employ temperatures of 150 to 300° C.

Preference is given to preparation by process alternative d). Preparation of the O/W emulsion of the heterocyclic 3-membered-ring compound, more particularly an aziridine, in solution in a suitable organic solvent is accomplished optionally with addition of suitable emulsifiers and preferably with application of high shearing forces (e.g. Ultraturrax, ultrasound homogenizer, high-pressure homogenizer). The addition of the O/W emulsion of the heterocyclic 3-membered-ring compound, more particularly an aziridine, to the dispersion of the polymer phase takes place preferably with a low shearing force (e.g. paddle blade stirrers, paddle dryers). The charging of the polymer phase with the heterocyclic 3-membered-ring compound, more particularly with an aziridine, is accomplished preferably by exposure to high shearing forces of the resultant suspoemulsion, as for example by use of a bead mill.

Organic solvents that are suitable are, in particular, esters of dibasic carboxylic acids, examples being mixtures comprising diisobutyl adipate, diisobutyl glutarate and diisobutyl succinate (e.g. Rhodiasolv® DIB).

By “finely divided” is meant preferably an average particle size of less than 15 μm, preferably less than 6 μm.

Procedures d) to e) are carried out preferably at a temperature of 0 to 30° C., more particularly at 15 to 25° C.

Procedure f) is carried out preferably at a temperature of 20 to 110° C., more particularly at 50 to 95° C.

Also preferred, furthermore, is preparation by process alternative f).

Optionally further additions may be added in the case of all of the procedures, in solid, liquid, or dissolved, dispersed or emulsified form.

Suitable methods for preparing polymer latices equipped with biocides are described in WO 2005/102044, for example.

The finely divided polymers and polymer latices stated in versions c)-e) of the process alternatives of the invention may be obtained, for example, by grinding of the corresponding polymers, preferably:
a. by dry grinding, as for example by air jet mills, and subsequent dispersing of the resultant polymers powders in water, optionally with addition of dispersing assistants, or
b. by wet grinding, as for example using a bead mill and optionally with addition of dispersing assistants.

The finely divided polymers and polymer latices stated in versions c)-e) of the composition of the invention may be prepared by radical, aqueous emulsion polymerization, more particularly micro-emulsion polymerization, referred to generally below as emulsion polymerization. The polymerization in this case takes place in analogy to conventional emulsion polymerization, with the difference that the monomer emulsion to be polymerized additionally comprises the iodine-containing compound and also the heterocyclic 3-membered-ring compound in solution in the monomer droplets.

The polymerization by process alternative f) of the invention, or the polymer dispersions used according to alternatives d) and e), take place preferably according to what is called a monomer feed process; in other words, the major amount, preferably at least 70% and more particularly at least 90% of the solution of the additives, in this case, therefore, the iodine-containing compound and/or the heterocyclic 3-membered-ring compound, in the monomers M, and/or the major amount, preferably at least 70% and more particularly at least 90% of the monomer/additive emulsion, is supplied to the polymerization vessel in the course of the polymerization reaction. The monomer/additive solution or emulsion is added preferably over a period of at least 0.5 h, preferably at least 1 h, e.g. 1 to 10 h and more particularly 2 to 6 h. The monomer/additive solution or emulsion can be added with constant or varying rate of addition, e.g. in intervals with a constant rate of addition or with varying rate of addition, or continuously with varying rate of addition. The composition of the monomer/additive solution or emulsion may remain constant or be changed in the course of the addition, with changes being possible in respect both of the monomer composition and of the nature of the additive or concentration of the additive.

One preferred polymerization according to process alternative f) of the invention, or for the polymer dispersions used according to alternatives d) and e), is that known as staged polymerization, characterized in that, in the course of the addition of monomer, the monomer composition is changed such that polymer regions with different glass transition temperatures are obtained in the polymer particles.

One particularly preferred polymerization is the conduct of the polymerization without emulsifier (=emulsifier-free emulsion polymerization), in which case the polymer particles which form are stabilized by the copolymerized, charge-carrying or potentially charge-carrying monomers M^{3a} and/or M^{3c}, which give the polymer that forms a positive or negative net charge. In this case, the charge-carrying or potentially charge-carrying monomers M^{3a} and M^{3c} may be present in solution in the monomer mixture M or in the aqueous phase.

For the preparation of the polymers of the invention it has proved to be advantageous if the emulsion polymerization is conducted in the presence of a seed polymer (seed latex). This is a finely divided polymer latex whose average particle size is typically not more than 100 nm, in particular not more than 80 nm and more preferably not more than 50 nm, in each case determined by laser diffraction (for example with a Coulter LS from Beckmann Coulter). The constituent monomers of the seed latex comprise preferably
a) at least 30% by weight, preferably 40% to 99.5% by weight and more preferably 50% to 98% by weight, of at least one of the monomers M¹,
b) 0.1% to 60% by weight, in particular 0.5% to 50% by weight, of at least one of the monomers M²,
c) 0.01% to 40% by weight, in particular 0.1% to 30%, of at least one of the monomers M³.

The amount of seed latex is typically 0.01% to 10% by weight, more particularly 0.1% to 6% by weight, based on the monomers M to be polymerized. The major amount, and in particular the total amount of the seed latex, is preferably located all in the reaction vessel at the beginning of the polymerization. The seed latex may also be generated in situ in the polymerization vessel by radical emulsion polymerization of the monomers that form the seed latex, in which case the monomers that form the seed latex are selected from the aforementioned monomers M¹, M² and M³. The desired particle size of the seed latex can be controlled in a conventional way by the ratio of monomer to emulsifier or, in the case of an emulsifier-free procedure, via the ratio of the non-charge-carrying monomers M¹, M² and M^{3b} to the charge-carrying monomers M^{3a} and M^{3c}.

The polymerization takes place with particular preference as what is called a miniemulsion polymerization (see, for example, F. J. Schork, G. W. Poehlein, S. Wang, J. Reimers, J. Rodrigues, C. Samer, Colloids Surf. A: Physicochem. Eng. Asp. 1999, 153, 39), which is characterized in that first of all an emulsion comprising monomers M, additives in the above sense, emulsifier, co-emulsifier soluble in the monomers M, and water is prepared by application of high shearing or shearing energy, as for example through use of stator-rotor dispersing tools, ultrasonic probes, etc., with droplet sizes <10 μm, preferably <6 μm and more particularly <1 μm, after which the discrete, monomer-containing oil droplets of the emulsion are converted into a polymeric phase by addition of free-radical initiators and optionally elevated temperature. Suitable co-emulsifiers include in principle the compounds described in the literature on the topic of “miniemulsion polymerization”, examples being long-chain alkanes such as hexadecane, and also the hydrophobic monomers M¹ stated in the present invention, such as stearyl methacrylate, for example.

The initiators suitable for the emulsion or miniemulsion polymerization of the invention are the polymerization initiators which are suitable and commonly used for an emulsion or miniemulsion polymerization, that initiate a radical polymerization of the monomers M. These initiators include azo compounds such as 2,2′-azobisisobutyronitrile, 2,2′-azobis(2-methylbutyronitrile), 2,2′-azobis[2-methyl-N-(2-hydroxyethyl)propionamide], 1,1′-azobis(1-cyclohexanecarbonitrile), 2,2′-azobis(2,4-dimethylvaleronitrile), 2,2′-azobis(N,N′-dimethyleneisobutyroamidine) dihydrochloride, and 2,2′-azobis(2-amidinopropane)dihydrochloride, organic or inorganic peroxides such as diacetyl peroxide, di-tert-butyl peroxide, diamyl peroxide, dioctanoyl peroxide, didecanoyl peroxide, dilauroyl peroxide, dibenzoyl peroxide, bis(o-tolyl)peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate, salts of peroxodisulphuric acid such as, for example, sodium peroxodisulphate, and redox initiator systems.

It is preferred to use water-soluble initiators, examples being cationic azo compounds such as azobis(dimethylamidinopropane), salts of peroxodisulphuric acid, more particularly a sodium, potassium or ammonium salt, or a redox initiator system which acts as oxidizing agent for a salt of the peroxodisulphuric acid, hydrogen peroxide or an organic peroxide such as tert-butyl hydroperoxide. As reducing agents they comprise preferably a sulphur compound, selected more particularly from sodium hydrogen sulphite, sodium hydroxymethanesulphinate and the adduct of hydrogen sulphite with acetone. Further suitable reducing agents are phosphorus-containing compounds such as phosphorous acid, hypophosphites and phosphinates, and also hydrazine or hydrazine hydrate and ascorbic acid. It is additionally possible for redox initiator systems to contain an addition of small amounts of redox metal salts such as iron salts, vanadium salts, copper salts, chromium salts or manganese salts, such as the ascorbic acid/iron(II) sulphate/sodium peroxodisulphate redox initiator system, for example.

The initiator is used typically in an amount of 0.02% to 2% by weight and more particularly 0.05% to 1.5% by weight, based on the amount of monomers M. The optimum amount of initiator is of course dependent on the initiator system used, and can be determined by the skilled person in routine experiments. The initiator may be included wholly or partially in the initial charge to the reaction vessel. It is preferred to add the major amount of the initiator, more particularly at least 80%, e.g. 80% to 99.5% of the initiator, in the course of the polymerization into the polymerization reactor, by means of metering pumps, for example.

Pressure and temperature are of minor importance for the preparation of the polymers of the invention. The temperature is of course dependent on the initiator system used, and an optimum polymerization temperature may be determined by the skilled person by means of routine experiments. Typically the polymerization temperature is in the range from 20 to 110° C., frequently in the range from 50 to 95° C. The polymerization is typically carried out under atmospheric pressure or ambient pressure. It may alternatively be carried out at elevated pressure, e.g. up to 3 bar, or at slightly reduced pressure, e.g. >800 mbar.

For the conduct of the preferred process alternative 1) of the invention, particularly of the emulsion polymerizations, it is advisable to stabilize the polymer particles in the aqueous medium. Except for the emulsifier-free process, surface-active substances, examples being emulsifiers and protective colloids, are advantageous for stabilizing the polymers of the invention in the form of dispersions. These substances include not only protective colloids but also low molecular weight emulsifiers, the latter, in contradistinction to the protective colloids, preferably having a molecular weight of below 2000 g/mol, more particularly below 1000 g/mol (mass average). The protective colloids and emulsifiers may be cationic, anionic, neutral or zwitterionic in nature.

Examples of anionic surface-active substances are anionic emulsifiers such as alkylphenylsulphonates, phenylsulphonates, alkyl sulphates, alkylsulphonates, alkyl ether sulphates, alkylphenol ether sulphates, alkyl polyglycol ether phosphates, alkyl diphenylethersulphonates, polyaryl phenyl ether phosphates, alkylsulphosuccinates, olefinsulphonates, paraffinsulphonates, petroleumsulphonates, taurides, sarcosides, fatty acids, alkylnaphthalenesulphonic acids, naphthalenesulphonic acids, including their alkali metal, alkaline earth metal, ammonium and amine salts. Examples of anionic protective colloids are lignosulphonic acids, condensation products of sulphonated naphthalenes with formaldehyde or with formaldehyde and phenol and optionally urea, and also condensation products of phenolsulphonic acid, formaldehyde and urea, lignin-sulphite waste liquor and lignosulphonates, and also polycarboxylates such as polyacrylates, maleic anhydride/olefin copolymers (e.g. Sokalan® I CP9, BASF), and also the alkali metal, alkaline earth metal, ammonium and amine salts of the aforementioned protective colloids.

Nonionic emulsifiers are, for example, alkylphenol alkoxylates, alcohol alkoxylates, fatty amine alkoxylates, polyoxyethylene-glycerol fatty acid esters, castor oil alkoxylates, fatty acid alkoxylates, fatty acid amide alkoxylates, fatty acid polydiethanolamides, lanolin ethoxylates, fatty acid polyglycolesters, isotridecylalcohol, fatty acid amides, methylcellulose, fatty acid esters, silicone oils, alkylpolyglycosides and glycerol fatty acid esters. Examples of nonionic protective colloids are polyethylene glycol, polypropylene glycol, polyethylene glycol-polypropylene glycol block copolymers, polyethylene glycol alkyl ethers, polypropylene glycol alkyl ethers, polyethylene glycol-polypropylene glycol ether block copolymers and mixtures thereof.

Examples of cationic emulsifiers are quaternary ammonium salts, e.g. trimethyl- and triethyl-C₆-C₃₀ alkyl-ammonium salts such as cocotrimethylammonium salts, trimethylcetylammonium salts, dimethyl- and diethyl-di-C₄-C₂₀ alkyl-ammonium salts such as didecyldimethylammonium salts and dicocodimethylammonium salts, methyl- and ethyl-tri-C₄-C₂₀ alkyl-ammonium salts such as methyltrioctylammonium salts, C₁-C₂₀ alkyl-di-C₁-C₄ alkyl-benzylammonium salts such as triethylbenzylammonium salts and cocobenzyldimethylammonium salts, methyl- and ethyl-di-C₄-C₂₀ alkyl-poly(oxyethyl)ammonium salts, e.g. didecylmethylpoly(oxyethyl)ammonium salts, N—C₆-C₂₀ alkyl-pyridinium salts, e.g. N-laurylpyridinium salts, N-methyl- and N-ethyl-N—C₆-C₂₀ alkyl-morpholinium salts, and also N-methyl- and N-ethyl-N′—C₆-C₂₀ alkyl-imidazolinium salts, more particularly the halides, borates, carbonates, formates, acetates, propionates, hydrogencarbonates, sulphates and methosulphates.

Examples of cationic protective colloids are homopolymers and copolymers of the abovementioned monomers M^{3a} and M^{3c}, with a monomers M^{3a} or M^{3c} content of at least 20% by weight, more particularly at least 30% by weight, examples being homopolymers of N-vinyl-N-methylimidazolinium salts or of N-alkylvinylpyridinium salts, and also copolymers of these monomers with neutral, preferably water-miscible monomers M^{3b}. Zwitterionic emulsifiers are those with betainic structures. Substances of this kind are known to the skilled person and can be found in the relevant prior art (see, for example, R. Heusch, in Ullmanns Encylopedia of industrial Chemistry, 5th ed. on CD-ROM, Wiley-VCH 1997, “Emulsions”, Chapter 7, Table 4).

The polymers of the invention can be used in solid form, for example as powders or granules, or in liquid form, in particular as dispersions in water or organic solvents (latices). Correspondingly, the invention also provides polymer preparations comprising at least one auxiliary in addition to the polymer of the invention.

Preferred polymer preparations are aqueous polymer dispersions comprising the polymer of the invention and preferably wetting agents, thickeners, defoamers, preservatives and/or stabilizers.

The wetting agents employed preferably have a low vapour pressure at room temperature. Wetting agents which can be used are all wetting agents typically used in dispersions, examples being polycondensates of naphthalenesulphonic acid and/or salts thereof. It is preferred to use oligo- or polyalkylene glycols or triols, or ethers of the aforementioned compounds, having a molecular weight, in particular, of less than 1000 g/mol. Very preferred are ethylene glycol, diethylene glycol, triethylene glycol, tetraethylene glycol, polyethylene glycol, propylene glycol, dipropylene glycol, polypropylene glycol, glycerol or mono- or di-methyl, ethyl, propyl or butyl ethers of the aforementioned compounds. The fraction of wetting agents may be varied within a relatively wide range. It is preferred to use 1% to 10% by weight, in particular 2% to 7% by weight, based on the polymer preparations of the invention, more particularly the polymer dispersion.

As thickeners it is possible in principle to use all substances which in water build up a three-dimensional structure and hence are able to prevent or retard sedimentation. Preference is given to using polysaccharides, xanthan gum, sodium or magnesium silicates, heteropolysaccharides, alginates, carboxymethylcellulose, gum arabic or polyacrylic acids. It is especially preferred to use xanthan gum. The fraction of thickeners in the polymer preparations, more particularly the polymer dispersion, is preferably 0.1% to 0.5% by weight, in particular 0.3% to 0.4% by weight, based on the dispersion.

Defoamers used are, in general, surface-active compounds which have only a slight solubility in the surfactant solution. Preference is given to defoamers which derive from natural fats and oils, petroleum derivatives or silicone oils. The fraction of defoamers in the polymer preparations of the invention, more particularly the polymer dispersion, is preferably 0.01% to 2% by weight, in particular 0.05% to 1% by weight, based on the dispersion.

As preservatives, which are optionally present in addition, it is possible to use all bactericides which possess an antimicrobial activity in the desired sense. In this context it is possible optionally to use one or more of these substances.

The stabilizers that are optionally employable may be antioxidants, free-radical scavengers or UV absorbers. One or more of these substances, optionally, may be employed. The fraction of these auxiliaries as a proportion of the polymer preparations of the invention, more particularly of the polymer dispersions, is preferably 0.1% to 3% by weight, in particular 0.5% to 2% by weight, based on the dispersion.

The polymer latices obtained in accordance with versions c)-f) of the process of the invention, and loaded with iodine-containing compound and heterocyclic 3-membered-ring compound, may be employed in this form as a stabilized presentation form of the iodine-containing biocide. The polymer of the invention, in the form of the aqueous dispersion, may optionally be isolated from its latex, in accordance with process alternatives c) to f) of the invention, by means of suitable isolation methods such as, for example, filtration, spray drying, fluid-bed drying etc. The polymeric material of the invention obtained in this way may optionally also be deaggregated by use of an annular sieve mill.

The polymers of the invention in the form of their dispersions may comprise either no emulsifier or at least one emulsifier. Where they comprise at least one emulsifier, they preferably comprise at least one nonionic emulsifier and optionally one or more ionic emulsifiers.

The amount of emulsifier is typically 0.1% to 15% by weight, in particular from 0.2% to 12% by weight, and more preferably 0.7% to 10% by weight, based on the mixture comprising monomers M and active ingredient or on the polymer.

The polymer preparation of the invention may comprise, as preferred compounds, for example, solvents such as, for example, esters of monobasic or polybasic carboxylic acids (e.g. mixtures comprising diisobutyl adipate, diisobutyl glutarate, diisobutyl succinate), preferably VOC-free or low-VOC solvents, where VOC means volatile organic compounds having a boiling point of less than 250° C.; chelating reagents as specified in WO 98/22543, for example; one or more stabilizers from the series of the antioxidants, free-radical scavengers, UV stabilizers and/or UV absorbers; and also further biocides (for examples, see below). In many cases, synergistic effects are observed here. The compositions of the invention may comprise, as described, the isolated polymer phase or a dispersion of the polymer phase in water or organic solvents. The loading of the polymer phase of the composition of the invention may for these compounds as well take place preferably in analogy to processes a)-f) (see above). The provision of the continuous phase of the aforementioned dispersions may take place by dissolution, optionally with addition of solubilizers, emulsification, etc.

With particular preference, the polymer preparation of the invention takes the form of a solid preparation, such as, for example, a powder or granules, more particularly having an average particle size of 50 to 2000 μm, or a compacted formulation, such as, for example, compacted powder such as, for example, pellets, tablets, etc.

Likewise with particular preference, the polymer preparation of the invention takes the form of a solvent-based dispersion, where, in order to adjust the rheological properties of the dispersion, for example, alkyd resins, modified alkyd resins, thixotropic resins, etc., and also further additives such as anti-skinning agents (antioxidants), pigments, crystallization stabilizers, etc., may be added.

Further possible ingredients of the polymer preparation of the invention that may be contained include adhesives such as carboxymethylcellulose, natural and synthetic polymers in powder, particle or latex form, such as gum arabic, polyvinyl alcohol, polyvinyl acetate, and also natural phospholipids, such as cephalins and lecithins, and synthetic phospholipids, and also mineral and vegetable oils. Moreover, it may comprise colorants such as inorganic pigments, e.g. iron oxide, titanium oxide, Prussian Blue, and organic dyes, such as alizarin dyes, azo dyes and metal phthalocyanine dyes, and trace nutrients, such as salts of iron, manganese, boron, copper, cobalt, molybdenum and zinc, and also stabilizers known for heterocyclic 3-membered-ring compounds, in particular aziridine compounds, examples being tetramethylethylenediamine (TMEDA), triethylenediamine, and the 1,4-diazabicyclo[2.2.2]octane (DABCO) known from WO 2004/050617.

The invention further provides a process for preparing the polymer preparation of the invention.

The polymer preparation of the invention may be prepared, for example, by mixing the polymer of the invention with further biocides (see below) and adjuvants such as, for example, flow improvers, additives for increasing the electrical conductivity, additives for adjusting the dusting characteristics, etc. These constituents may alternatively be employed during the actual preparation of the polymer itself by the process of the invention. For preparing the polymer preparation of the invention in the form of solids mixtures, use is made here, optionally after pretreatment of the components that are to be mixed, using, for example, sieve mills such as the Bauermeister mill, of suitable solids mixers such as, for example, Lödige mixers, paddle mixers, tumble mixers, drum mixers with disruptors, etc. Additionally, the conversion of resultant solids mixtures into further embodiments, such as granules, compacted forms such as pillows, tablets, etc., for example is possible with use of fluid-bed granulation, use of mechanical compacting systems, optionally with addition of further additives such as binders, for example.

Another embodiment of the polymer preparation of the invention is a solvent-based dispersion. In this case, the composition of the invention is ground and dispersed (e.g. bead mill), preferably with strong shearing, in, for example, one of the abovementioned inert, organic solvents as the continuous phase (e.g. isoparaffins such as Isopar® L (isoparaffin from Exxon) or “white spirits” such as, for example, Shellsol® D60), optionally with addition of process auxiliaries and stabilizers such as, for example, rheological additives (thixotroping resins such as, for example, WorleeThix® S6358, a thixotroped alkyd resin from Worlee) and optionally anti-skinning agents such as, for example, Antiskin® 444 (from Borchers).

Furthermore, a further-processing of the polymer preparation of the invention, in the form, for example, of the aqueous polymer latex described above, by means, for example, of furnishing with further additives, such as, for example, rheological additives (e.g. xanthans), pigments, anti-settling agents, etc., represents a formulation according to the invention.

The activity and the spectrum of action of the polymers or of the polymer preparation or of the compositions described below of the invention and/or of the iodine-containing compound employed may be increased by adding, optionally, further antimicrobial compounds, fungicides, bactericides, herbicides, insecticides or other active compounds, so as to widen the spectrum of activity or to obtain particular effects, or by using such compounds at the same time. These mixtures may possess an even broader spectrum of action. These compounds may be used either in the preparation of the polymer of the invention or thereafter in the preparation of the polymer preparation of the invention.

In many cases, synergistic effects are obtained, i.e. the activity of the mixture is greater than the activity of the individual components. The following compounds, for example, are particularly favourable co-components:

triazoles such as:
azaconazole, azocyclotin, bitertanol, bromuconazole, cyproconazole, diclobutrazole, difenoconazole, diniconazole, epoxyconazole, etaconazole, fenbuconazole, fenchlorazole, fenethanil, fluquinconazole, flusilazole, flutriafol, furconazole, hexaconazole, imibenconazole, ipconazole, isozofos, myclobutanil, metconazole, paclobutrazole, penconazole, propioconazole, prothioconazole, simeconazole, (±)-cis-1-(4-chlorophenyl)-2-(1H-1,2,4-triazol-1-yl)cycloheptanol, 2-(1-tert-butyl)-1-(2-chlorophenyl)-3-(1,2,4-triazol-1-yl)propan-2-ol, tebuconazole, tetraconazole, triadimefon, triadimenol, triapenthenol, triflumizole, triticonazole, uniconazole and their metal salts and acid adducts;
imidazoles such as:
clotrimazole, bifonazole, climbazole, econazole, fenapamil, imazalil, isoconazole, ketoconazole, lombazole, miconazole, pefurazoate, prochloraz, triflumizole, thiazolcar, 1-imidazolyl-1-(4′-chlorophenoxy)-3,3-dimethylbutan-2-one, and their metal salts and acid adducts;
pyridines and pyrimidines such as:
ancymidol, buthiobate, fenarimol, mepanipyrin, nuarimol, pyvoxyfur, triamirol;
succinate dehydrogenase inhibitors such as:
benodanil, carboxim, carboxim sulphoxide, cyclafluramid, fenfuram, flutanil, furcarbanil, furmecyclox, mebenil, mepronil, methfuroxam, metsulphovax, nicobifen, pyracarbolid, oxycarboxin, Shirlan, Seedvax;
naphthalene derivatives such as:
terbinafine, naftifine, butenafine, 3-chloro-7-(2-aza-2,7,7-trimethyloct-3-en-5-yne);
sulphenamides such as:
dichlofluanid, tolylfluanid, folpet, fluorofolpet, captan, captofol;
benzimidazoles such as:
carbendazim, benomyl, fuberidazole, thiabendazole or their salts;
morpholine derivatives such as:
aldimorph, dimethomorph, dodemorph, falimorph, fenpropidin, fenpropimorph, tridemorph, trimorphamid and their arylsulphonate salts such as, for example, p-toluenesulphonic acid and p-dodecylphenylsulphonic acid;
benzothiazoles such as:
2-mercaptobenzothiazole;
benzothiophene dioxides such as:
N-cyclohexyl-benzo[b]thiophenecarboxamide S,S-dioxide;
benzamides such as:
2,6-dichloro-N-(4-trifluoromethylbenzyl)benzamide, tecloftalam;
boron compounds such as:
boric acid, boric esters, borax;
formaldehyde and formaldehyde-releasing compounds such as:
benzyl alcohol mono(poly)hemiformal, 1,3-bis(hydroxymethyl)-5,5-dimethylimidazolidine-2,4-dione (DMDMH), bisoxazolidine, n-butanol hemiformal, cis-1-(3-chloroallyl)-3,5,7-triaza-1-azoniaadamantane chloride, 1-[1,3-bis(hydroxymethyl-2,5-dioxoimidazolidin-4-yl]-1,3-bis(hydroxymethyl)urea, dazomet, dimethylolurea, 4,4-dimethyloxazolidine, ethylene glycol hemiformal, 7-ethylbicyclooxazolidine, hexahydro-5-triazine, hexamethylenetetramine, N-hydroxymethyl-N′-methylthiourea, methylenebismorpholine, sodium N-(hydroxymethyl)glycinate, N-methylolchloroacetamide, oxazolidine, paraformaldehyde, taurolin, tetrahydro-1,3-oxazine, N-(2-hydroxypropyl)aminemethanol, tetramethylolacetylenediurea (TMAD);
isothiazolinones such as:
N-methylisothiazolin-3-one, 5-chloro-N-methylisothiazolin-3-one, 4,5-dichloro-N-octylisothiazolin-3-one, 5-chloro-N-octylisothiazolinone, N-octylisothiazolin-3-one, 4,5-trimethyleneisothiazolinone, 4,5-benzoisothiazolinone;
aldehydes such as:
cinnamaldehyde, formaldehyde, glutaraldehyde, β-bromocinnamaldehyde, o-phthalaldehyde;
thiocyanates such as:
thiocyanatomethylthiobenzothiazole, methylenebisthiocyanate;
quaternary ammonium compounds and guanidines such as:
benzalkonium chloride, benzyldimethyltetradecylammonium chloride, benzyldimethyldodecylaminonium chloride, dichlorobenzyldimethylalkylammonium chloride, didecyldimethylammonium chloride, dioctyldimethylammonium chloride, N-hexadecyltrimethylammonium chloride, 1-hexadecylpyridinium chloride, iminoctadine tris(albesilate);
phenols such as:
tribromophenol, tetrachlorophenol, 3-methyl-4-chlorophenol, 3,5-dimethyl-4-chlorophenol, dichlorophene, 2-benzyl-4-chlorophenol, triclosan, diclosan, hexachlorophene, methyl p-hydroxybenzoate, ethyl p-hydroxybenzoate, propyl p-hydroxybenzoate, butyl p-hydroxybenzoate, octyl p-hydroxybenzoate, o-phenylphenol, m-phenylphenol, p-phenylphenol, 4-(2-tert-butyl-4-methylphenoxy)phenol, 4-(2-isopropyl-4-methylphenoxy)phenol, 4-(2,4-dimethylphenoxy)phenol and their alkali metal salts and alkaline earth metal salts;
microbicides with an activated halogen group such as:
bronopol, bronidox, 2-bromo-2-nitro-1,3-propanediol, 2-bromo-4′-hydroxyacetophenone, 1-bromo-3-chloro-4,4,5,5-tetramethyl-2-imidazolidinone, β-bromo-β-nitrostyrene, chloracetamide, chloramine T, 1,3-dibromo-4,4,5,5-tetramethyl-2-imidazolidinone, dichloramine T, 3,4-dichloro-(3H)-1,2-dithiol-3-one, 2,2-dibromo-3-nitrilepropionamide, 1,2-dibromo-2,4-dicyanobutane, halane, halazone, mucochloric acid, phenyl 2-chlorocyanovinyl sulphone, phenyl 1,2-dichloro-2-cyanovinyl sulphone, trichloroisocyanuric acid;
pyridines such as:
1-hydroxy-2-pyridinethione (and the Cu, Na, Fe, Mn, Zn salts thereof), tetrachloro-4-methylsulphonylpyridine, pyrimethanol, mepanipyrim, dipyrithion, 1-hydroxy-4-methyl-6-(2,4,4-trimethylpentyl)-2(1H)-pyridine;
methoxyacrylates or similar such as:
azoxystrobin, dimoxystrobin, fluoxastrobin, kresoxim-methyl, metominostrobin, orysastrobin, picoxystrobin, pyraclostrobin, trifloxystrobin, 2,4-dihydro-5-methoxy-2-methyl-4-[2-[[[[1-[3-(trifluoromethyl)phenyl]ethylidene]amino]oxy]methyl]phenyl]-3H-1,2,4-triazol-3-one (CAS No. 185336-79-2);
metal soaps such as:
salts of the metals tin, copper and zinc with higher fatty acids, resin acids, naphthenic acids and phosphoric acid, such as, for example, tin naphthenate, tin octoate, tin 2-ethylhexanoate, tin oleate, tin phosphate, tin benzoate, copper naphthenate, copper octoate, copper 2-ethylhexanoate, copper oleate, copper phosphate, copper benzoate, zinc naphthenate, zinc octoate, zinc 2-ethylhexanoate, zinc oleate, zinc phosphate, zinc benzoate;
metal salts such as:
salts of the metals tin, copper, zinc, and also chromates and dichromates, such as, for example, copper hydroxycarbonate, sodium dichromate, potassium dichromate, potassium chromate, copper sulphate, copper chloride, copper borate, zinc fluorosilicate, copper fluorosilicate;
oxides such as:
oxides of the metals tin, copper and zinc, such as, for example, tributyltin oxide, Cu₂O, CuO, ZnO;
oxidizing agents such as:
hydrogen peroxide, peracetic acid, potassium persulphate;
dithiocarbamates such as:
cufraneb, ferban, potassium N-hydroxymethyl-N′-methyldithiocarbamate, sodium dimethyldithiocarbamate, potassium dimethyldithiocarbamate, mancozeb, maneb, metam, metiram, thiram, zineb, ziram;
nitriles such as:
2,4,5,6-tetrachloroisophthalonitrile, disodium cyanodithioimidocarbamate;
quinolines such as:
8-hydroxyquinoline and the copper salts thereof;
other fungicides and bactericides such as:
bethoxazin, 5-hydroxy-2(5H)-furanone, 4,5-benzodithiazolinone, 4,5-trimethylenedithiazolinone, N-(2-p-chlorobenzoylethyl)hexaminium chloride, 2-oxo-2-(4-hydroxyphenyl)acetohydroxycinnamoyl chloride, tris-N-(cyclohexyldiazeniumdioxy)-aluminium, N-(cyclohexyldiazeniumdioxy)-tributyltin or its potassium salts, bis-N-(cyclohexyldiazeniumdioxy) copper, iprovalicarb, fenhexamide, spiroxamine, carpropamid, diflumetorin, quinoxyfen, famoxadone, polyoxorim, acibenzolar S-methyl, furametpyr, thifluzamide, methalaxyl-M, benthiavalicarb, metrafenon, cyflufenamid, tiadinil, tea tree oil, phenoxyethanol,
Ag, Zn or Cu-containing zeolites alone or incorporated into polymeric materials.

Very especially preferred are mixtures with

azaconazole, bromuconazole, cyproconazole, dichlobutrazol, diniconazole, diuron, hexaconazole, metaconazole, penconazole, propiconazole, tebuconazole, dichlofluanid, tolylfluanid, fluorfolpet, methfuroxam, carboxin, N-cyclohexyl-benzo[b]thiophenecarboxamide S,S-dioxide, fenpiclonil, 4-(2,2-difluoro-1,3-benzodioxol-4-yl)-1H-pyrrole-3-carbonitrile, butenafine, imazalil, N-methylisothiazolin-3-one, 5-chloro-N-methylisothiazolin-3-one, N-octylisothiazolin-3-one, dichloro-N-octylisothiazolinone, mercaptobenzothiazole, thiocyanatomethylthiobenzothiazole, thiabendazole, benzoisothiazolinone, N-(2-hydroxypropyl)aminomethanol, benzyl alcohol (hemi)formal, N-methylolchloroacetamide, N-(2-hydroxypropyl)aminemethanol, glutaraldehyde, omadine, Zn-omadine, dimethyl dicarbonate, 2-bromo-2-nitro-1,3-propanediol, bethoxazin, o-phthalialdehyde, 2,2-dibromo-3-nitrilepropionamide, 1,2-dibromo-2,4-dicyanobutane, 1,3-bis(hydroxymethyl)-5,5-dimethylimidazolidine-2,4-dione (DMDMH), tetramethylolacetylenediurea (TMAD), ethylene glycol hemiformal, p-hydroxybenzoic acid, carbendazim, chlorophen, 3-methyl-4-chlorophenol, o-phenylphenol.

Apart from with the abovementioned fungicides and bactericides, mixtures with a good efficacy are, moreover, also prepared with other active compounds:

insecticides/acaricides/nematicides:
abamectin, acephate, acetamiprid, acetoprole, acrinathrin, alanycarb, aldicarb, aldoxycarb, aldrin, allethrin, alpha-cypermethrin, amidoflumet, amitraz, avermectin, azadirachtin, azinphos A, azinphos M, azocyclotin,
Bacillus thuringiensis, barthrin, 4-bromo-2(4-chlorophenyl)-1-(ethoxymethyl)-5-(trifluoromethyl)-1H-pyrrole-3-carbonitrile, bendiocarb, benfuracarb, bensultap, betacyfluthrin, bifenthrin, bioresmethrin, bioallethrin, bistrilfluoron, bromophos A, bromophos M, bufencarb, buprofezin, butathiophos, butocarboxim, butoxycarboxim,
cadusafos, carbaryl, carbofuran, carbophenothion, carbosulphan, cartap, quinomethionate, cloethocarb, chlordane, chlorethoxyfos, chlorfenapyr, chlorfenvinphos, chlorfluazuron, chlormephos, N-[(6-chloro-3-pyridinyl)methyl]-N′-cyano-N-methylethaneimidamide, chlorpicrin, chlorpyrifos A, chlorpyrifos M, cis-resmethrin, clocythrin, clothiazoben, cypophenothrin, clofentezin, coumaphos, cyanophos, cycloprothrin, cyfluthrin, cyhalothrin, cyhexatin, cypermethrin, cyromazin,
decamethrin, deltamethrin, demeton M, demeton S, demeton-S-methyl, diafenthiuron, dialiphos, diazinon, 1,2-dibenzoyl-1(1,1-dimethyl)hydrazine, DNOC, dichlofenthion, dichlorvos, dicliphos, dicrotophos, difethialone, diflubenzuron, dimethoate, 3,5-dimethylphenyl methylcarbamate, dimethyl(phenyl)silylmethyl-3-phenoxybenzyl ether, dimethyl(4-ethoxyphenyl)silylmethyl-3-phenoxybenzyl ether, dimethylvinphos, dioxathion, disulphoton,
eflusilanate, emamectin, empenthrin, endosulphan, EPN, esfenvalerate, ethiofencarb, ethion, ethofenprox, etrimphos, etoxazole, etobenzanid,
fenamiphos, fenazaquin, fenbutatin oxide, fenfluthrin, fenitrothion, fenobucarb, fenothiocarb, fenoxycarb, fenpropathrin, fenpyrad, fenpyroximate, fensulphothion, fenthion, fenvalerate, fipronil, flonicamid, fluacrypyrim, fluazuron, flucycloxuron, flucythrinate, flufenerim, flufenoxuron, flupyrazofos, flufenzine, flumethrin, flufenprox, fluvalinate, fonophos, formethanate, formothion, fosmethilan, fosthiazate, fubfenprox, furathiocarb,
halofenozide, HCH, (CAS RN: 58-89-9), heptenophos, hexaflumuron, hexythiazox, hydramethylnon, hydroprene,
imidacloprid, imiprothrin, indoxycarb, iprinomectin, iprobenfos, isazophos, isoamidophos, isofenphos, isoprocarb, isoprothiolane, isoxathion, ivermectin,
kadedrin,
lambda-cyhalothrin, lufenuron,
malathion, mecarbam, mervinphos, mesulphenphos, metaldehyde, methacrifos, methamidophos, methidathion, methiocarb, methomyl, metolcarb, milbemectin, monocrotophos, moxiectin,
naled, NI 125, nicotine, nitenpyram, noviflumuron,
omethoate, oxamyl, oxydemethon M, oxydeprofos,
parathion A, parathion M, penfluoron, permethrin, 2-(4-phenoxyphenoxy)ethyl ethylcarbamate, phenthoate, phorate, phosalon, phosmet, phosphamidon, phoxim, pirimicarb, pirimiphos M, pirimiphos A, prallethrin, profenophos, promecarb, propaphos, propoxur, prothiophos, prothoate, pymetrozin, pyrachlophos, pyridaphenthion, pyresmethrin, pyrethrum, pyridaben, pyridalyl, pyrimidifen, pyriproxifen, pyrithiobac-sodium,
quinalphos,
resmethrin, rotenone,
salithion, sebufos, silafluofen, spinosad, spirodiclofen, spiromesifen, sulphotep, sulprofos,
tau-fluvalinate, taroils, tebufenozide, tebufenpyrad, tebupirimphos, teflubenzuron, tefluthrin, temephos, terbam, terbufos, tetrachlorvinphos, tetramethrin, tetramethacarb, thiacloprid, thiafenox, thiamethoxam, thiapronil, thiodicarb, thiofanox, thiazophos, thiocydam, thiomethon, thionazin, thuringiensin, tralomethrin, transfluthrin, triarathen, triazophos, triazamate, triazuron, trichlorfon, triflumuron, trimethacarb,
vamidothion, xylylcarb, zetamethrin;
molluscicides:
fentin acetate, metaldehyde, methiocarb, niclosamide;
herbicides and algicides:
acetochlor, acifluorfen, aclonifen, acrolein, alachlor, alloxydim, ametryn, amidosulphuron, amitrole, ammonium sulphamate, anilofos, asulam, atrazine, azafenidin, aziptrotryne, azimsulphuron,
benazolin, benfluralin, benfuresate, bensulphuron, bensulphide, bentazone, benzofencap, benzthiazuron, bifenox, bispyribac, bispyribac-sodium, borax, bromacil, bromobutide, bromofenoxim, bromoxynil, butachlor, butamifos, butralin, butylate, bialaphos, benzoyl-prop, bromobutide, butroxydim,
carbetamide, carfentrazone-ethyl, carfenstrole, chlomethoxyfen, chloramben, chlorbromuron, chlorflurenol, chloridazon, chlorimuron, chlomitrofen, chloroacetic acid, chloransulam-methyl, cinidon-ethyl, chlorotoluron, chloroxuron, chlorpropham, chlorsulphuron, chlorthal, chlorthiamid, cinmethylin, cinosulphuron, clefoxydim, clethodim, clomazone, chlomeprop, clopyralid, cyanamide, cyanazine, cycloate, cycloxydim, chloroxynil, clodinafop-propargyl, cumyluron, clometoxyfen, cyhalofop, cyhalofop-butyl, clopyrasuluron, cyclosulphamuron,
diclosulam, dichlorprop, dichlorprop-P, diclofop, diethatyl, difenoxuron, difenzoquat, diflufenican, diflufenzopyr, dimefuron, dimepiperate, dimethachlor, dimethipin, dinitramine, dinoseb, dinoseb acetate, dinoterb, diphenamid, dipropetryn, diquat, dithiopyr, diduron, DNOC, DSMA, 2,4-D, daimuron, dalapon, dazomet, 2,4-DB, desmedipham, desmetryn, dicamba, dichlobenil, dimethamid, dithiopyr, dimethametryn,
eglinazine, endothal, EPTC, esprocarb, ethalfluralin, ethidimuron, ethofumesate, ethobenzanid, ethoxyfen, ethametsuiphuron, ethoxysulphuron,
fenoxaprop, fenoxaprop-P, fenuron, flamprop, flamprop-M, flazasulphuron, fluazifop, fluazifop-P, fuenachior, fluchloralin, flufenacet, flumeturon, fluorocglycofen, fluoronitrofen, flupropanate, flurenol, fluridone, fluorochloridone, fluoroxypyr, fomesafen, fosamine, fosametine, flamprop-isopropyl, flamprop-isopropyl-L, flufenpyr, flumiclorac-pentyl, flumipropyn, flumioxzim, flurtamone, flumioxzim, flupyrsulphuron-methyl, fluthiacet-methyl,
glyphosate, glufosinate-ammonium
haloxyfop, hexazinone,
imazamethabenz, isoproturon, isoxaben, isoxapyrifop, imazapyr, imazaquin, imazethapyr, ioxynil, isopropalin, imazosulphuron, imazomox, isoxaflutole, imazapic,
ketospiradox,
lactofen, lenacil, linuron,
MCPA, MCPA-hydrazide, MCPA-thioethyl, MCPB, mecoprop, mecoprop-P, mefenacet, mefluidide, mesosulphuron, metam, metamifop, metamitron, metazachlor, methabenzthiazuron, methazole, methoroptryne, methyldymron, methyl isothiocyanate, metobromuron, metoxuron, metribuzin, metsulphuron, molinate, manacle, monolinuron, MSMA, metolachlor, metosulam, metobenzuron,
naproanilide, napropamide, naptalam, neburon, nicosulphuron, norflurazon, sodium chlorate,
oxadiazon, oxyfluorfen, oxysulphuron, orbencarb, oryzalin, oxadiargyl,
propyzamide, prosulphocarb, pyrazolate, pyrazosulphuron, pyrazoxyfen, pyribenzoxim, pyributicarb, pyridate, paraquat, pebulate, pendimethalin, pentachlorophenol, pentoxazone, pentanochlor, petroleum oils, phenmedipham, picloram, piperophos, pretilachlor, primisulphuron, prodiamine, profoxydim, prometryn, propachlor, propanil, propaquizafob, propazine, propham, propisochlor, pyriminobac-methyl, pelargonic acid, pyrithiobac, pyraflufen-ethyl,
quinmerac, quinocloamine, quizalofop, quizalofop-P, quinchlorac,
rimsulphuron,
sethoxydim, sifuron, simazine, simetryn, sulphosulphuron, sulphometuron, sulphentrazone, sulcotrione, sulphosate,
tar oils, TCA, TCA-sodium, tebutam, tebuthiuron, terbacil, terbumeton, terbuthylazine, terbutryn, thiazafluoron, thifensulphuron, thiobencarb, thiocarbazil, tralkoxydim, triallate, triasulphuron, tribenuron, triclopyr, tridiphane, trietazine, trifluoralin, tycor, thdiazimin, thiazopyr, triflusulphuron, vemolate.

The invention further provides a polymer characterized in that the polymer is constructed of ethylenically unsaturated monomers M, as described above in general and in particular, comprising at least one aziridine compound, with the preferred embodiments for the polymer, the aziridine compound and also amount and preparation corresponding to those indicated above. This aziridine-containing polymer is preferably free from iodine-containing compounds.

The invention further provides for the use of a polymer of the invention of this kind for stabilizing iodine-containing compounds, more particularly those stated above. The invention further provides a composition comprising
a) at least one polymer comprising at least one aziridine compound and
b) at least one iodine-containing compound.

The invention further provides for the use of the polymers of the invention, described at the outset, and also the inventive composition as a stable and stabilizing form of presentation of iodine-containing compounds, more particularly biocides.

The polymers or the polymer preparations of the invention for use in accordance with the use are suitable preferentially for stabilizing iodine-containing compounds, more particularly biocides, in binder formulations, such as in alkyd-resin-based systems such as coating materials which comprise transition metal dryers, in particular in the presence of transition metal dryers. Preferred binder formulations and transition metal dryers are described in more detail later on below.

Stabilization in the context of this specification means preferably the stabilization of iodine-containing compounds against both chemical and light-induced degradation, particularly against chemical degradation.

The polymers of the invention and the compositions of the invention may more particularly be used for suppressing or at least retarding the chemical degradation of iodine-containing compounds, more particularly biocides in active-compound formulations, more particularly coating materials such as paints, varnishes, primers, impregnating systems, stains and other industrial materials. The compositions of the invention that can be used in accordance with the invention for stabilizing iodine-containing compounds, more particularly biocides, have a good stabilizing action especially in alkyd-resin-based systems such as coating materials which comprise transition metal dryers.

The invention further provides a binder formulation comprising
at least one binder,
at least one polymer of the invention and/or
at least one composition of the invention.

The polymer of the invention may, in this case, also be in the form of the polymer preparation of the invention.

Preferred binders contemplated include oxidatively drying binders, preferably alkyd-resin-based binders, or binders which form films by means of coalescents, especially latices.

The alkyd-resin-based binders contemplated are preferably alkyd resins and modified alkyd resins.

The alkyd resins are, in general, polycondensation resins formed from polyols and polybasic carboxylic acids and/or their anhydrides, and fats, oils or free natural and/or synthetic fatty acids. The alkyd resins may optionally also be modified chemically with hydrophilic groups, especially water-soluble groups, in order that they can be used, for example, as an emulsifiable or as a water-soluble alkyd resin.

The stated polyols are preferably glycerol, pentaerythritol, trimethylolethane, trimethylolpropane and various dials such as ethane-/propanediol, diethylene glycol and neopentyl glycol.

The stated polybasic carboxylic acids and/or their anhydrides are preferably phthalic acid, phthalic anhydride, maleic anhydride, isophthalic acid, terephthalic acid, trimellitic anhydride, adipic acid, azelaic acid or sebacic acid.

The stated oils or fatty acids are generally linseed oil, oiticica oil, tung oil, soya oil, sunflower oil, safflower oil, ricinene oil, tall oil, castor oil, coconut oil, peanut oil, their fatty acids, and also synthetic saturated, unsaturated or polyunsaturated monocarboxylic acids or mixtures of these components.

The alkyd resins can optionally also be modified with, for example, natural resins, phenolic resins, acrylic resins, styrene, epoxy resins, silicone resins, isocyanates, polyamides or aluminium alkoxides.

The alkyd resins generally have a molar mass of 500 to 100 000 g/mol, preferably of 1000 to 50 000 g/mol, more particularly of 1500 to 20 000 g/mol, (determined by laser light scattering; see, for example, “Static Light Scattering of Polystyrene Reference Materials: Round Robin Test”, U. Just, B. Werthmann International Journal of Polymer Analysis and Characterization, 1999 Vol. 5, pages 195-207).

The binder formulations of the invention comprise preferably 1% to 80%, more preferably 2% to 70% and with particular preference 3% to 60% by weight of alkyd resin.

The binder formulation of the invention preferably comprises an alkyd-resin-based binder and a transition metal dryer for oxidative drying. Transition metal dryers for the purposes of this specification are more particularly transition metal compounds which accelerate the drying and curing of the alkyd-resin-based binder.

Preference is given to the salts of transition metals of groups Vb, VIb, VIIb, VIII and Ib of the chemical periodic system. These are more particularly the salts of cobalt, manganese, vanadium, nickel, copper and iron, more preferably cobalt, manganese, iron and vanadium. They need not necessarily be used alone, but instead can also be employed in combination with non-transition metal salts, such as lead, calcium or zirconium, for example.

The preferred transition metal salts are soluble in organic solvents, for example, white spirit at 20° C. in an amount of more than 10 g/l. The salts in question are preferably the salts of carboxylic acids, which have high compatibility with the alkyd resin binders and at the same time ensure sufficient solubility of the metal salt. Preference is given to using transition metal salts of fatty acids, such as oleates or linoleates, resin acids such as resinates, or salts of 2-ethylhexanoic acid (octoates). Preferred transition metal dryers are cobalt octoate and cobalt naphthenate, e.g. Octasoligen®-Cobalt 12 from Borchers.

The binder formulations of the invention preferably comprise the transition metal dryers in an amount of 0.001% to 1%, preferably 0.005% to 0.5% and very preferably 0.01% to 0.1% by weight, based in each case on binder.

In one preferred embodiment the binder formulations comprise at least one polar organic solvent, preferably a polar aprotic solvent. Examples of suitable such polar protic solvents are those such as dipropylene glycol monomethyl ether (e.g. Dowanol DPM from Dow Chemical) and also, preferably, in combination thereto, polar aprotic solvents, such as dimethylformamide and dimethyl sulphoxide, and also, for example, etherified glycols, oligoglycols and polyglycols, etherified polyols and esterified polyols, esters of monobasic and polybasic carboxylic acids, e.g. diisobutyl adipate, diisobutyl maleate, (e.g. Rhodiasolv DIB).

Particular preference is given to the binder formulation comprising

1% to 80%, preferably 2% to 70%, more preferably 3% to 60% by weight of alkyd resin binder(s)
0% to 50%, preferably 0% to 45%, more preferably 0% to 40% by weight of colour pigments
0.01% to 10%, preferably 0.05% to 5%, more preferably 0.1% to 4% by weight of polymer of the invention or composition of the invention,
2% to 97% by weight of solvent(s), more particularly non-polar or polar solvents, including preferably up to 10%, more particularly 0.01% to 7.5%, by weight, based on the binder preparation, of polar aprotic solvents, and
0.001% to 3% by weight of a transition metal dryer.

Particularly preferred binder formulations of the invention are those comprising at least one alkyd resin, at least one transition metal dryer, at least one solvent and at least one composition of the invention or formulation of the invention.

The binder formulation may further comprise fillers, anti-skinning agents, rheological additives such as, for example, anti-settling agents and thixotropic agents, further biocides such as fungicides, bactericides, anti-fouling agents and algicides, solvents, process additives, plasticizers, UV stabilizers and heat stabilizers, and also corrosion inhibitors, in customary amounts.

It is additionally possible to add further stabilizers to the binder formulations, examples being the chelating reagents specified in WO 98/22543, or other heterocyclic 3-membered-ring compounds, in particular those with a different heteroatom from that which was used in the composition of the invention or formulation of the invention. In the case of aziridines, these are preferably the organic epoxides specified in WO 00/16628. In many cases synergistic effects are observed here.

In the context of the inventive use it is also possible, furthermore, to add one or more stabilizers from the group consisting of antioxidants, free-radical scavengers, UV stabilizers, chelators and UV absorbers, which in some cases exhibit synergistic effects. These substances may optionally also already be used in the preparation of the polymer of the invention and be contained in the polymer.

Further UV stabilizers that may be mentioned include, by way of example, the following:

sterically hindered phenols, such as
2,6-di-tert-butyl-4-methylphenol, 2-tert-butyl-4,6-dimethylphenol, 2,6-di-cyclopentyl-4-methylphenol, 2-α-methylcyclohexyl)-4,6-dimethylphenol, 2,6-di-octadecyl-4-methylphenol or 2,6-di-tert-butyl-4-methoxymethylphenol, diethyl (3,5-di-tert-butyl-4-hydroxybenzyl)phosphonate, 2,4-dimethyl-6-(1-methylpentadecyl)phenol, 2-methyl-4,6-bis[(octylthio)methyl]phenol, 2,6-di-tert-butyl-4-methoxyphenol, 2,5-di-tert-butylhydroquinone, 2,5-di-tert-amylhydroquinone, 2,6-diphenyl-4-octadecyloxyphenol, 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 2,2′-methylenebis(6-tert-butyl-4-methylphenol), 2,2′-methylenebis(4-methyl-6-cyclohexylphenol), 2,2′-methylenebis(4,6-di-tert-butylphenol), 2,2′-ethylidenebis(4,6-di-tert-butylphenol), 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 1,1,3-tris(5-tert-butyl-4-hydroxy-2-methylphenyl)butane, 1,3,5-tri(3,5-di-tert-butyl-4-hydroxybenzyl)-2,4,6-trimethylbenzene, isooctyl 3,5-di-tert-butyl-4-hydroxybenzylmercaptoacetate, 1,3,5-tris(3,5-di-tert-butyl-4-hydroxybenzyl) isocyanurate, 1,3,5-tris(4-tert-butyl-3-hydroxy-2,6-dimethylbenzyl)isocyanurate, 1,3,5-tris(3,5-di-tert-butyl-4-hydroxyphenyl)propionyloxyethyl]isocyanurate, dioctadecyl 3,5-di-tert-butyl-4-hydroxybenzylphosphonate, calcium monoethyl 3,5-di-tert-butyl-4-hydroxybenzylphosphonate, N,N′-di-(3,5-di-tert-butyl-4-hydroxyphenylpropionyl)hexamethylenediamine, N,N′-di-(3,5-di-tert-butyl-4-hydroxyphenylpropionyl)trimethylenediamine, N,N′-di-(3,5-di-tert-butyl-4-hydroxyphenylpropionyl)hydrazine, 3,9-bis[1,1-d]methyl-2-[(3-tert-butyl-4-hydroxy-5-methylphenyl)propionyloxy]ethyl]-2,4,8,10-tetraoxaspiro[5.5]undecane, bis[3,3-bis(4′-hydroxy-3′-tert-butylphenyl)butanoic acid]ethylene glycol ester, 2,6-bis[[3-(1,1-dimethylethyl)-2-hydroxy-5-methylphenyl]octahydro-4,7-methano-1H-indenyl]-4-methylphenol (=Wingstay L), 2,4-bis(n-octylthio)-6-(3,5-di-tert-butyl-4-hydroxyphenylamino)-s-triazine, N-(4-hydroxyphenyl)octadecaneamide, 2,4-di-tert-butylphenyl 3′,5′-di-tert-butyl-4′-hydroxybenzoate, (benzoic acid, 3,5-bis(1,1-dimethylethyl)-4-hydroxy-, hexadecyl ester), 3-hydroxyphenyl benzoate, 2,2′-methylenebis(6-tert-butyl-4-methylphenol)monoacrylate, dimethylethyl)-6-[1-[3-(1,1-dimethylethyl)-5-(1,1-dimethylpropyl)-2-hydroxyphenyl]ethyl]-4-(1,1-dimethylpropyl)phenyl ester, esters of β-(3,5-di-tert-butyl-4-hydroxyphenyl)propionic acid with monohydric or polyhydric alcohols such as, for example, with methanol, octadecanol, 1,6-hexanediol, neopentyl glycol, thiodiethylene glycol, diethylene glycol, triethylene glycol, pentaerythritol, trishydroxyethyl isocyanurate or dihydroxyethyloxalamide, esters of β-(5-tert-butyl-4-hydroxy-3-methylphenyl)propionic acid with monohydric or polyhydric alcohols such as, for example, with methanol, octadecanol, 1,6-hexanediol, neopentyl glycol, thiodiethylene glycol, diethylene glycol, triethylene glycol, pentaerythritol, trishydroxyethyl isocyanurate or dihydroxyethyloxalamide.
Hindered amines, such as
bis(1,2,2,6,6-pentamethyl-4-piperidyl) 2-(3,5-di-tert-butyl-4-hydroxybenzyl)-2-butylmalonate, bis(2,2,6,6-tetramethyl-4-piperidyl)decanedioate, dimethyl succinate-1-(2-hydroxyethyl)-4-hydroxy-2,2,6,6-tetramethylpiperidine copolymer, poly[[6-[(1,1,3,3-tetramethylbutyl)amino]-1,3,5-triazine-2,4-diyl][(2,2,6,6-tetramethyl-4-piperidyl)imino]hexamethylene[(2,2,6,6-tetramethyl-4-piperidyl)imino]] (CAS No. 71878-19-8), 1,5,8,12-tetrakis[4,6-bis(n-butyl-n-1,2,2,6,6-pentamethyl-4-piperidylamino)-1,3,5-triazin-2-yl]-1,5,8,12-tetraazadodecane (CAS No. 106990-43-6), bis(1,2,2,6,6-pentamethyl-4-piperidyl)decanedioate, bis(1,2,2,6,6-pentamethyl-4-piperidyl) 2-(3,5-di-tert-butyl-4-hydroxybenzyl)-2-butylmalonate, decanedioic acid, bis(2,2,6,6-tetramethyl-4-piperidinyl) ester, reaction products with tert-butyl hydroperoxide and octane (CAS No. 129757-67-1), Chimasorb 2020 (CAS No. 192268-64-7), poly[[6-morpholino-1,3,5-triazine-2,4-diyl][(2,2,6,6-tetramethyl-4-piperidinyl)imino]-1,6-hexanediyl[(2,2,6,6-tetramethyl-4-piperidinyl)imino]], poly[[6-(4-morpholinyl)-1,3,5-triazine-2,4-diyl][(1,2,2,6,6-pentamethyl-4-piperidinyl)imino]-1,6-hexanediyl[(1,2,2,6,6-pentamethyl-4-piperidinyl)imino]] (9CI), 3-dodecyl-1-(2,2,6,6-tetramethyl-4-piperidyl)pyrrolidine-2,5-dione, 3-dodecyl-1-(1,2,2,6,6-pentamethylpiperidin-4-yl)pyrrolidine-2,5-dione, 4-octadecanoyloxy-2,2,6,6-tetramethylpiperidine, poly[[6-(cyclohexylamino)-1,3,5-triazine-2,4-diyl][(2,2,6,6-tetramethyl-4-piperidinyl)imino]-1,6-hexanediyl[(2,2,6,6-tetramethyl-4-piperidinyl)imino]], 1H,4H,5H,8H-2,3a,4a,6,7a,8a-hexaazacyclopenta[def]fluorene-4,8-dione, hexahydro-2,6-bis(2,2,6,6-tetramethyl-4-piperidinyl)- (CAS No. 109423-00-9), N,N′-bis(formyl)-N,N′-bis(2,2,6,6-tetramethyl-4-piperidyl)-1,6-hexanediamine, N-(tetramethyl-4-piperidinyl)maleimide-C20-24-α-olefin copolymer (CAS No. 199237-39-3), tetrakis(1,2,2,6,6-pentamethyl-4-piperidyl) 1,2,3,4-butanetetracarboxylate, tetrakis(2,2,6,6-tetramethyl-4-piperidyl) 1,2,3,4-butanetetracarboxylate, 1,2,2,6,6-pentamethyl-4-piperidinyl tridecyl 1,2,3,4-butanetetracarboxylate, (1,2,3,4-butanetetracarboxylic acid, 2,2,6,6-tetramethyl-4-piperidinyl tridecyl ester), (2,4,8,10-tetraoxaspiro[5.5]undecane-3,9-diethanol, β,β,β′,β′-tetramethyl-, polymer with 1,2,3,4-butanetetracarboxylic acid) (CAS No. 115055-30-6), 2,2,4,4-tetramethyl-21-oxo-7-oxa-3,20-diazadispiro[5.1.11.2]heneicosane, (7-oxa-3,20-diazadispiro[5.1.11.2]heneicosane-20-propanoic acid, 2,2,4,4-tetramethyl-21-oxo-, tetradecyl ester), (7-oxa-3,20-diazadispiro[5.1.11.2]heneicosan-21-one, 2,2,4,4-tetramethyl-20-(oxiranylmethyl)-), (propanamide, N-(2,2,6,6-tetramethyl-4-piperidinyl)-3-[(2,2,6,6-tetramethyl-4-piperidinyl)amino]-), (1,3-propanediamine, N,N″′-1,2-ethanediylbis-, polymer with 2,4,6-trichloro-1,3,5-triazine, reaction products with N-butyl-2,2,6,6-tetramethyl-4-piperidinamine) (CAS No. 136504-96-6), 1,1′-ethylenebis(3,3,5,5-tetramethyl-2-piperazinone), (piperazinone, 1,1′,1″-[1,3,5-triazine-2,4,6-triyltris[(cyclohexylimino)-2,1-ethanediyl]]tris[3,3,5,5-tetramethyl-), (7-oxa-3,20-diazadispiro[5.1.11.2]heneicosane-20-propanoic acid, 2,2,4,4-tetramethyl-21-oxo-, dodecyl ester), 1,1-bis(1,2,2,6,6-pentamethyl-4-piperidyloxycarbonyl)-2-(4-methoxyphenyl)ethene, (2-propenoic acid, 2-methyl-, methyl ester, polymer with 2,2,6,6-tetramethyl-4-piperidinyl 2-propenoate) (CAS No. 154636-12-1), (propanamide, 2-methyl-N-(2,2,6,6-tetramethyl-4-piperidinyl)-2-[(2,2,6,6-tetramethyl-4-piperidinyl)amino]-) (D-glucitol, 1,3:2,4-bis-O-(2,2,6,6-tetramethyl-4-piperidinylidene)-) (CAS No. 99473-08-2), N,N′-bis(2,2,6,6-tetramethyl-4-piperidinyl)isophthalamide, 4-hydroxy-2,2,6,6-tetramethylpiperidine, 1-allyl-4-hydroxy-2,2,6,6-tetramethylpiperidine, 1-benzyl-4-hydroxy-2,2,6,6-tetramethylpiperidine, 1-(4-tert-butyl-2-butenyl)-4-hydroxy-2,2,6,6-tetramethylpiperidine, 4-stearoyloxy-2,2,6,6-tetramethylpiperidine, 1-ethyl-4-salicyloyloxy-2,2,6,6-tetramethylpiperidine, 4-methacryloyloxy-1,2,2,6,6-pentamethylpiperidine, 1,2,2,6,6-pentamethylpiperidin-4-yl β-(3,5-ditert-butyl-4-hydroxyphenyl)propionate, 1-benzyl-2,2,6,6-tetramethyl-4-piperidinyl maleate, (di-2,2,6,6-tetramethylpiperidin-4-yl) adipate, (di-2,2,6,6-tetramethylpiperidin-4-yl) sebacate, (di-1,2,3,3,6-tetramethyl-2,6-diethylpiperidin-4-yl) sebacate, (di-1-allyl-2,2,6,6-tetramethylpiperidin-4-yl) phthalate, 1-propargyl-4-β-cyanoethyloxy-2,2,6,6-tetramethylpiperidine, 1-acetyl-2,2,6,6-tetramethylpiperidin-4-yl acetate, trimellitic acid tri(2,2,6,6-tetramethylpiperidin-4-yl)ester, 1-acryloyl-4-benzyloxy-2,2,6,6-tetramethylpiperidine, dibutyl-malonic acid di(1,2,2,6,6-pentamethylpiperidin-4-yl) ester, butyl(3,5-di-tert-butyl-4-hydroxybenzyl)malonic acid di(1,2,2,6,6-pentamethylpiperidin-4-yl) ester, dibenzylmalonic acid di(1,2,2,6,6-pentamethylpiperidin-4-yl) ester, dibenzylmalonic acid di(1,2,3,6-tetramethyl-2,6-diethylpiperidin-4-yl) ester, hexane-1′,6′-bis-(4-carbamoyloxy-1-n-butyl-2,2,6,6-tetramethylpiperidine), toluene-2′,4′-bis(4-carbamoyloxy-1-n-propyl-2,2,6,6-tetramethylpiperidine), dimethyl-bis(2,2,6,6-tetramethylpiperidine-4-oxy)silane, phenyl-tris(2,2,6,6-tetramethylpiperidine-4-oxy)silane, tris(1-propyl-2,2,6,6-tetramethylpiperidin-4-yl) phosphite, tris(1-propyl-2,2,6,6-tetramethylpiperidin-4-yl) phosphate, phenyl[bis(1,2,2,6,6-pentamethylpiperidin-4-yl)phosphonate, di(1,2,2,6,6-pentamethylpiperidin-4-yl) sebacate, N,N′-bis(2,2,6,6-tetramethylpiperidin-4-yl)hexamethylene-1,6-diamine, N,N′-bis(2,2,6,6-tetramethylpiperidin-4-yl)hexamethylene-1,6-diacetamide, 1-acetyl-4-(N-cyclohexylacetamido)-2,2,6,6-tetramethylpiperidine, 4-benzylamino-2,2,6,6-tetramethylpiperidine, N,N′-bis(2,2,6,6-tetramethylpiperidin-4-yl)-N,N′-dibutyladipamide, N,N′-bis(2,2,6,6-tetramethylpiperidin-4-yl)-N,N′-dicyclohexyl(2-hydroxypropylene), N,N′-bis(2,2,6,6-tetramethylpiperidin-4-yl)-p-xylylenediamine, 4-(bis-2-hydroxyethyl)amino-1,2,2,6,6-pentamethylpiperidine, 4-(3-methyl-4-hydroxy-5-tert-butyl-benz-amido)-2,2,6,6-tetramethylpiperidine, 4-methacrylamino-1,2,2,6,6-pentamethylpiperidine, 9-aza-8,8,10,10-tetramethyl-1,5-dioxaspiro[5.5]undecane, 9-aza-8,8,10,10-tetramethyl-3-ethyl-1,5-dioxaspiro[5.5]undecane, 8-aza-2,7,7,8,9,9-hexamethyl-1,4-dioxaspiro[4.5]decane, 9-aza-3-hydroxymethyl-3-ethyl-8,8,9,10,10-pentamethyl-1-5-dioxaspiro[5.5]undecane, 9-aza-3-ethyl-3-acetoxymethyl-9-acetyl-8,8,10,10-tetramethyl-1,5-dioxaspiro[5.5]undecane, 2,2,6,6-tetramethylpiperidine-4-spiro-2′-(1′,3′-dioxane)-5′-spiro-5″-(1″,3″-dioxane)-2″-spiro-4″-(2′″,2′″,6′″,6′″-tetramethylpiperidine)-3-benzyl-1,3,8-triaza-7,7,9,9-tetramethyl-spiro[4.5]decane-2,4-dione, 3-n-octyl-1,3,8-triaza-7,7,9,9-tetramethyl-spiro-[4.5]decane-2,4-dione, 3-allyl-1,3,8-triaza-1,7,7,9,9-pentamethyl-spiro[4.5]decane-2,4-dione, 3-glycidyl-1,3,8-triaza-7,7,8,9,9-pentamethyl-spiro[4.5]decane-2,4-dione, 2-isopropyl-7,7,9,9-tetramethyl-1-oxa-3,8-diaza-4-oxyspiro[4.5]decane, 2-butyl-7,7,9,9-tetramethyl-1-oxa-3,8-diaza-4-oxyspiro[4.5]decane, 2-isopropyl-7,7,9,9-tetramethyl-1-oxa-4,8-diaza-oxyspiro[4.5]decane, 2-butyl-7,7,9,9-tetramethyl-1-oxa-4,8-diaza-3-oxyspiro[4.5]decane, bis[β-(2,2,6,6-tetramethylpiperidino)ethyl]sebacate, α-(2,2,6,6-tetramethylpiperidino)acetic acid n-octyl ester, 1,4-bis(2,2,6,6-tetramethylpiperidino)-2-butene, N-hydroxymethyl-N′-2,2,6,6-tetramethylpiperidin-4-ylurea, N-methoxymethyl-N′-2,2,6,6-tetramethylpiperidin-4-ylurea, N-methoxymethyl-N′-n-dodecyl-N′-2,2,6,6-tetramethylpiperidin-4-ylurea, O-(2,2,6,6-tetramethylpiperidin-4-yl)-N-methoxymethylurethane.
Phosphites and phosphonates, such as
tris(nonylphenyl) phosphite, tris(2,4-di-tert-butylphenyl) phosphite, bis(2,4-di-tert-butylphenyl) pentaerythritol diphosphite, bis(2,6-di-tert-butyl-4-methylphenyl)pentaerythritol diphosphite, 2,2′-methylenebis(4,6-di-tert-butylphenyl) octyl phosphite, tetrakis(2,4-di-tertbutylphenyl)[1,1′-biphenyl]-4,4′-diylbisphosphonite, 2,2′-ethylidenebis(4,6-di-tert-butylphenyl) fluorophosphite, dioctadecyl pentaerythritol diphosphonite, 2-[[2,4,8,10-tetrakis(1,1-dimethylethyl)dibenzo[d,f][1,3,2]dioxaphosphin-6-yl]oxy]-N,N-bis[2-[[2,4,8,10-tetrakis(1,1-dimethylethyl)dibenzo[d,f][1,3,2]dioxaphosphin-6-yl]oxy]ethyl]ethanamine (CAS No. 80410-33-9), bis(2,4-di-tert-butyl-6-methylphenyl)ethyl phosphite, 2,4,6-tri-tert-butylphenyl 2-butyl-2-ethyl-1,3-propanediol phosphite or bis(2,4-dicumylphenyl)pentaerythritol diphosphite,
hydroxylamines, such as
N,N-bis(2-carboxyethyphydroxylamine, N,N-bis(benzylthiomethyphydroxylamine, N,N-diethylhydroxylamine, etc.
secondary arylamines, such as
N-(2-naphthyl)-N-phenylamine, 2,2,4-trimethyl-1,2-dihydroquinoline polymer (CAS No. 26780-96-1), N-2-propyl-N-phenyl-p-phenylenediamine, N-(1-naphthyl)-N-phenylamine, (benzenamine, N-phenyl-, reaction products with 2,4,4-trimethylpentene) (CAS No. 68411-46-1) or 4-(1-methyl-1-phenylethyl)-N-[4-(1-methyl-1-phenylethyl)phenyl]aniline.
Lactones and benzofuranones, such as

### Irganox HP 136 (CAS No. 181314-48-7)

Thioethers and thioesters, such as
distearyl 3,3-thiodipropionate, dilauryl 3,3′-thiodipropionate, ditetradecyl thiodipropionate, di-n-octadecyl disulphide.
UV absorbers, such as
(methanone, [methylenebis(hydroxymethoxyphenylene)]bis[phenyl-), (methanone, [1,6-hexanediylbis[oxy(2-hydroxy-4,1-phenylene]]bis[phenyl-), 2-benzoyl-5-methoxyphenol, 2,4-dihydroxybenzophenone, 2,2′-dihydroxy-4-methoxybenzophenone, 2-hydroxy-4-octyloxybenzophenone, 2-hydroxy-4-dodecyloxybenzophenone, 2-(2-hydroxy-4-hexyloxyphenyl)-4,6-diphenyl-1,3,5-triazine, 2,4-bis(2,4-dimethylphenyl)-6-(2-hydroxy-4-octyloxyphenyl)-1,3,5-triazine, 2-ethoxy-2′-ethyloxalic acid bisanilide, N-(5-tert-butyl-2-ethoxyphenyl)-N′-(2-oxamide, dimethyl(p-methoxybenzylidene)malonate, 2,2′-(1,4-phenylene)bis[3,1-benzoxazin-4-one], N′-(4-ethoxycarbonylphenyl)-N-methyl-N-phenylformamidine, 4-methoxycinnamic acid 2-ethylhexyl ester, 4-methoxycinnamic acid isoamyl ester, 2-phenylbenzimidazole-5-sulphonic acid, 2-cyano-3,3-diphenylacrylic acid 2-ethylhexyl ester, 2-ethylhexyl salicylate or 3-(4-methylbenzylidene)bornan-2-one,
Chelators, such as
ethylenediaminetetraacetate (EDTA), ethylenediamine, acetylacetone, nitrotriacetic acid, ethylene glycol bis(β-aminoethyl ether)-N,N-tetraacetic acid, 2,2′-bipyridine, 4,4′-dimethyl-2,2′-bipyridine, 2,2′,6′,2″-terpyridine, 4,4′-diphenyl-2,2′-bipyridine, 2,2′-bipyridine-3,3′-diol, 1,10-phenanthroline, 4-methyl-1,10-phenanthroline, 5-methyl-1,10-phenanthroline, 4,7-dimethyl-1,10-phenanthroline, 5,6-dimethyl-1,10-phenanthroline, 3,4,7,8-tetramethyl-1,10-phenanthroline, 4,7-diphenyl-1,10-phenanthroline, 2,4,7,9-tetramethyl-1,10-phenanthroline, N,N,N′,N′-tetramethylethylenediamine, 2-hydroxyquinoline, 8-hydroxyquinoline, 2-hydroxy-4-methylquinaldine, 5-chloro-8-hydroxyquinoline, 5,7-dichloro-8-hydroxyquinoline, 2,4-quinolinediol, 2-quinolinethiol, 8-quinolinethiol, 8-aminoquinoline, 2,2′-biquinoline, 2-quinoxalinol, 3-methyl-2-quinoxalinol, 2,3-dihydroxyquinoxaline, 2-mercaptopyridine, 2-dimethylaminopyridine, 1,2-bis(dimethylphosphino)ethane, 1,2-bis(diphenylphosphino)ethane, 1,3-bis(diphenylphosphino)propane, 1,4-bis(diphenylphosphino)butane, polyaspartic acid or iminodisuccinate.

Iodine-containing compounds, more particularly biocides, are degraded in particular in the presence of the dryers described in more detail above. Although the strongest effects are observed is in the presence of these dryers, a series of further paint components also have a destabilizing effect on iodine-containing compounds, more particularly biocides. These include organic and inorganic pigments, fillers, anti-skinning agents, rheological additives such as, for example, anti-settling agents and thixotropic agents, further compounds, particularly biocides such as fungicides, bactericides, anti-fouling agents and algicides, solvents, process additives, plasticizers, UV stabilizers and heat stabilizers, corrosion inhibitors, etc. The compositions/formulations of the invention also display a strongly stabilizing effect here.

The compositions/formulations of the invention, used in oxidatively drying binder preparations, and the binder preparations of the invention themselves exhibit a significant reduction in drying time as compared with unstabilized iodine-containing systems, particularly systems containing IPBC or no increase in drying time as compared with the systems not equipped with IPBC (known as blank formulations).

The binder formulations of the invention are used preferably as coating materials, more particularly as paints, varnishes, primers, impregnating systems and stains. Accordingly, the invention also provides for the use of the binder formulations of the invention as coating materials.

The invention further provides for the use of the polymers of the invention or of the composition of the invention for protecting industrial materials against destruction or infestation by microorganisms.

The polymers of the invention, for example in the form of their polymer preparations are suitable for protecting industrial materials. Industrial materials in the present context are non-living materials which have been prepared for use in industry. The industrial materials are, for example, adhesives, sizes, paper and cardboard, textiles, leather, wood, wood-based materials, coating materials and plastics articles, cooling lubricants and other materials which may be infested or decomposed by microorganisms.

Examples of microorganisms which may bring about degradation or alteration of the industrial materials include bacteria, fungi, yeasts, algae and slime organisms. The active compounds of the invention act preferably against fungi, more particularly moulds, wood-discolouring and wood-destroying fungi (Basidiomycetes) and also against slime organisms and bacteria.

Microorganisms of the following genera may be mentioned by way of example:

Alternaria, such as Alternaria tenuis,
Aspergillus, such as Aspergillus niger,
Chaetomium, such as Chaetomium globosum,
Coniophora, such as Coniophora puetana,
Lentinus, such as Lentinus tigrinus,
Penicillium, such as Penicillium glaucum,
Polyporus, such as Polyporus versicolor,
Aureobasidium, such as Aureobasidium pullulans,
Sclerophoma, such as Sclerophoma pityophila,
Trichoderma, such as Trichoderma viride,
Escherichia, such as Escherichia coli,
Pseudomonas, such as Pseudomonas aeruginosa,
Staphylococcus, such as Staphylococcus aureus.

The invention further provides industrial materials comprising at least the polymer of the invention or a composition of the invention.

### EXAMPLES

In the examples below, stability tests accelerated by storage at elevated temperature are carried out. The IPBC was assayed in all cases by HPLC.

### Examples 1-2

Examples 1-2 describe the preparation of inventive compositions.

### Example 1

### Emulsifier-Free Emulsion Polymerization (IPBC:Aziridine=4:1)

Monomer solution I: 40.0 g of IPBC and 10 g of Crosslinker CX-100 from DSM (trimethylolpropane tris[3-(2-methyl-1-aziridinyl)propionate], were dissolved in a mixture consisting of 74.85 g of methylmethacrylate, 13.2 g of stearyl methacrylate and 59 g of divinylbenzene.

In a polymerization apparatus, a solution of 2.63 g of sodium 4-vinylbenzenesulphonate and 2.43 g of sodium peroxodisulphate was admixed, with stirring, with 6 g of the monomer solution I, and the batch was heated to 70° C. and stirred for 30 minutes. Subsequently, the remainder of the monomer solution I was added dropwise over the course of 5 hours, and, after the end of the addition, the batch was stirred at 70° C. overnight. After cooling, the resulting dispersion was run through a bead mill, and the polymer phase was isolated from the resultant latex by spray drying (Büchi B-290 spray dryer, pump power 45%, N₂ flow 35 l*min⁻¹, inlet 160° C., outlet 73° C.). This gave 171.4 g of a fine powder (corresponding to 87% of theory) having an IPBC content of 18.1%.

### Example 2

### Miniemulsion Polymerization (IPBC:Aziridine=3:1)

Oil phase I: 60 g of IPBC were dissolved in a mixture containing 37.4 g of methyl methacrylate, 6.6 g of stearyl methacrylate and 29.5 g of divinyl benzene.

Emulsion I: A solution of 7.4 g of Tanemul® 508 (nonionic ethoxylated stearyl alcohol emulsifier from Tanatex), and 1.32 g of sodium 4-vinylbenzenesulphonate in 650 ml of water, was converted into an emulsion with the oil phase I, using an Ultraturrax (24 000 r min⁻¹, 10 minutes).

Polymer latex I: In a polymerization apparatus, a solution of 0.12 g of sodium peroxodisulphate in 20 ml of water was admixed with the emulsion I, and the batch was heated to 70° C. with stirring and then stirred for 20 minutes. Subsequently, a solution of 1.1 g of sodium perooxodisulphate in 20 ml of water was added, followed by stirring for a further 2.5 hours, and then a solution of 1.2 g of sodium peroxodisulphate in 10 ml of water was metered in over the course of 2 hours, followed by a further 3 hours of stirring, and then by cooling to room temperature.

Emulsion II: A solution containing 20 g of Crosslinker CX-100 from DSM (trimethylolpropane tris[3-(2-methyl-1-aziridinyl)propionate]), and also 10.7 g of Rhodiasolv® DIB (oil phase) was converted into an emulsion with a solution of 1.53 g of Tanemul® KS (ethoxylated castor oil) in 53.3 g of water by means of an Ultraturrax (24 000 r min⁻¹, 5 minutes).

The emulsion II was mixed with the polymer latex I with paddle blade stirring (10 minutes), the resulting suspoemulsion was run through a bead mill, and the polymer phase was isolated from the resultant latex by spray drying (Büchi B-290 spray dryer, pump output 55%, N₂ flow 35 l*min⁻¹, inlet 160° C., outlet 50° C.). Only the fine fraction was isolated, giving 114.3 g of a fine powder (corresponding to 70% of theory) having an IPBC content of 27.4%.

### Example 3

### Use of an Inventive Polymer in Binder Formulations

The IPBC- and aziridine-containing polymer from Example 2 (IPBC:aziridine ratio=3:1) was incorporated in a typical, alkyd-based coating system (alkyd stain A) in the presence of a transition metal dryer (Co) and a metal oxide pigment (iron oxide). For the equipping of the coating system, the aforementioned polymer, an IPBC concentrate containing IPBC and an aziridine in a ratio of 2:1 (see Table 1, reference II), and also IPBC (neat), as reference I, were used in each case.

TABLE 1
IPBC/aziridine concentrate (reference II)

| | |
|---|---|
| IPBC | 30% by weight |
| Crosslinker CX-100** | 15% by weight |
| Rhodiasolv DIB* | 55% by weight |

*Mixture of diisobutyl adipate, diisobutyl glutarate, diisobutyl succinate, Rhodia.
**Trimethylolpropane-tris[3-(2-methyl-1-aziridinyl)propionate]

The formula of the alkyd stain A used is shown in Table 2.

To determine the stabilization, an accelerated ageing test is carried out. For this purpose, the equipped paint system is introduced into tightly sealing 200 ml glass bottles, with only a minimum, residual amount of air remaining in the container, and stored at 40° C. The results can be seen from Table 3.

| | | | Ingredi- | Ingredi- |
|---|---|---|---|---|
| | | Ingredi- | ents of | ents of |
| | | ents of | alkyd stain | alkyd stain |
| | | alkyd stain | A-II [%] | A-III [%] |
| | Ingredients | A-I [%] | (Reference I) | (Reference II) |
| Alkyd | Vialkyd VAF 4349, | 22.5 | 22.5 | 22.5 |
| stain A | 80 SD 60, from | | | |
| | Cytec | | | |
| | Polar solvent | 5.0 | 5.0 | 5.0 |
| | Texanol, | | | |
| | from Eastman | | | |
| | Rheology additive | 0.4 | 0.4 | 0.4 |
| | BYK E411, from | | | |
| | BYK | | | |
| | Shellsol D60, from | 65.24 | 67.1 | 65.47 |
| | Shell Chemicals | | | |
| | MK-Solcolor red | 4.0 | 4.0 | 4.0 |
| | iron oxide 130M | | | |
| | (pigment prepara- | | | |
| | tion), from MK | | | |
| | Chemicals | | | |
| | Octa-Soligen ® 69 | 0.3 | 0.3 | 0.3 |
| | (contains 6% Co), | | | |
| | from Borchers | | | |
| | IPBC composition | 2.56¹⁾ | — | — |
| | from Example 2 | | | |
| | IPBC | — | 0.7 | — |
| | IPBC/aziridine | — | — | 2.33¹⁾ |
| | concentrate | | | |
| | (reference II) | | | |

¹⁾corresponds in each case to 0.7% by weight IPBC, based on the stain.

From Table 3 it is clear that the polymer equipped with a 3-membered-ring compound and IPBC, in terms of the stabilization of IPBC (see stain A-I), has a significantly higher stability than the unstabilized sample A-II. There is also a significant improvement relative to the IPBC sample stabilized only with aziridine, without the use of the polymer matrix encapsulation (stain A-III), although stain A-III has a greater aziridine/IPBC ratio (1/2 vs. 1/3).

TABLE 3
Stability of IPBC in alkyd stains A (-I) to (-IV) at 40° C.

| | Residual IPBC content [%], based on the initial value | | | |
|---|---|---|---|---|
| Alkyd stain | Initial | 2 weeks | 4 weeks | 8 weeks |
| A-I | 100 | 100 | 100 | 94 |
| A-II¹⁾ | 100 | 96 | 52 | 0 |
| A-III²⁾ | 100 | 100 | 80 | 0 |

¹⁾non-stabilized sample
²⁾aziridine stab. IPBC, without polymer matrix

### Example 4

### Use of an Inventive Polymer in Binder Formulations

The IPBC composition from Examples 1 and 2 was incorporated in a commercial high-build wood stain “alkyd stain B” (containing alkyd resin, white spirit, iron oxide pigment, dryer, butanone oxime, UV absorber and additives). To equip the coating system with 0.7% IPBC in each case, based on the stain, the compositions of Examples 1 and 2 and also unstabilized IPBC are used in each case (see Table 4):

TABLE 4
Alkyd stain B - I

| | |
|---|---|
| IPBC | 3.87% by weight¹⁾ |
| Composition from | |
| Example 1 | |
| Alkyd stain B | 96.13% by weight |

Alkyd stain B - II

| | |
|---|---|
| IPBC | 2.56% by weight¹⁾ |
| Composition from | |
| Example 2 | |
| Alkyd stain B | 97.44% by weight |

Alkyd stain B - III

| | |
|---|---|
| IPBC | 0.7% by weight |
| unstabilized | |
| Alkyd stain B | 99.3% by weight |

¹⁾corresponding in each case to 0.7% by weight IPBC, based on stain

The high-build stains under investigation, each equipped with 0.7% IPBC (alkyd stain B-I to alkyd stain B-III), were prepared by mixing the weight fractions of the alkyd stain B as indicated in Table 4 and also the stated IPBC-containing compositions.

For determining the stabilization, an accelerated ageing test is carried out. For this purpose, the equipped paint system is introduced into tightly sealing 200 ml glass bottles, with only a minimum, residual amount of air remaining in the container, and stored at 40° C. The results can be seen from Table 5, whereby only the alkyd stains B-I and B-II, equipped in accordance with the invention, exhibit no significant degradation of the IPBC after 4 weeks of storage at 40° C., in comparison to the unstabilized sample. The alkyd stain B-II, in particular, shows only a slight degradation of IPBC even after 8 weeks of storage at 40° C.

TABLE 5
Stability of IPBC in alkyd stains B (-I) to (-III) at 40° C.

| | Residual IPBC content [%], based on the initial value | | | |
|---|---|---|---|---|
| Alkyd stain B | Initial | 2 weeks | 4 weeks | 8 weeks |
| -I | 100 | 100 | 86 | 40 |
| -II | 100 | 100 | 100 | 87 |
| -III¹⁾ | 100 | 33 | 0 | 0 |

¹⁾non-stabilized sample

What is claimed is:

1. Polymer comprising at least one heterocyclic 3-membered-ring compound and an iodine-containing compound.

2. Polymer according to claim 1, characterized in that the heterocyclic 3-membered-ring compound is an epoxide or an aziridine, more particularly an aziridine.

3. Polymer according to claim 1, characterized in that the polymer is a natural, semi-synthetic and/or synthetic polymer.

4. Polymer according to claim 1, characterized in that the polymer is particulate, having more particularly an average particle size of less than 15 μm, in particular less than 10 μm and more preferably less than 6 μm.

5. Polymer according to claim 1, characterized in that the polymer is constructed of ethylenically unsaturated monomers M comprising:
at least 30% by weight, more particularly at least 40% by weight, very preferably at least 50% by weight, based on the total amount of the monomers M, of at least one neutral, monoethylenically unsaturated monomer M¹ having a water solubility of not more than 50 g/l at 25° C., preferably not more than 30 g/l at 25° C.,
up to 60% by weight, more particularly from 0.01 to 50% by weight, based on the total amount of the monomers M, of one or more polyethylenically unsaturated monomers M², different from the monomers M¹, and
up to 40% by weight, more particularly up to 0.01% to 40% by weight, based on the total amount of the monomers M, of one or more monomers M³ which are different from the monomers M¹ and M² and are charge-carrying or potentially charge-carrying or neutral and preferably not potentially charge-carrying, having a water solubility of more than 50 g/l at 25° C.

6. Polymer according to at claim 1, characterized in that the heterocyclic 3-membered-ring compound is an aziridine of the formula I 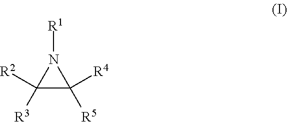
where
R¹ is hydrogen, alkyl or cycloalkyl, each of which are unsubstituted or substituted and/or mono- or polyethylenically unsaturated, or in each case substituted or unsubstituted fullerenyl, aryl, alkoxy, alkoxycarbonyl, arylcarbonyl, alkanoyl, carbamoyl or oxomethylene,
R², R³, R⁴ and R⁵ independently of one another have the same definition as R¹ and additionally independently are halogen, hydroxyl, carboxyl, alkylsulphonyl, arylsulphonyl, nitrile or isonitrile, or the radicals
R² and R⁴ or R³ and R⁵, together with the carbon atoms to which they are attached, form a 5- to 10-membered carbocyclic ring which is unsubstituted or substituted and/or mono- or polyethylenically unsaturated.

7. Polymer according to claim 1, comprising as iodine-containing compound at least diiodomethyl p-tolylsulphone, diiodomethyl p-chlorophenyl sulphone, 3-bromo-2,3-diiodo-2-propenyl alcohol, 2,3,3-triiodoallyl alcohol, 4-chloro-2-(2-chloro-2-methylpropyl)-5-[(6-iodo-3-pyridinyl)methoxy]-3(2H)-pyridazinone (CAS RN: 120955-77-3), iodofenfos, 3-iodo-2-propynyl 2,4,5-trichlorophenyl ether, 3-iodo-2-propynyl-4-chlorophenyl formal (IPCF), N-iodopropargyloxycarbonylalanine, ethyl N-iodopropargyloxycarbonylalanine, 3-(3-iodopropargyl)benzoxazol-2-one, 3-(3-iodopropargyl)-6-chlorobenzoxazol-2-one, 3-iodo-2-propynyl alcohol, 4-chlorophenyl-3-iodopropargyl formal, 3-iodo-2-propynyl propylcarbamate, 3-iodo-2-propynyl butylcarbamate (IPBC), 3-iodo-2-propynyl m-chlorophenylcarbamate, 3-iodo-2-propynyl phenylcarbamate, di(3-iodo-2-propynyl)hexyldicarbamate, 3-iodo-2-propynyloxyethanol ethylcarbamate, 3-iodo-2-propynyloxyethanol phenylcarbamate, 3-iodo-2-propynyl thioxothioethylcarbamate, 3-iodo-2-propynyl carbamate (IPC), 3-bromo-2,3-diiodo-2-propenyl ethylcarbamate, 3-iodo-2-propynyl n-hexylcarbamate or 3-iodo-2-propynyl cyclohexylcarbamate.

8. Polymer according to claim 1, comprising as iodine-containing compound at least IPBC.

9. Process for preparing polymers according to claim 1, characterized in that
a) at least one iodine-containing compound, at least one heterocyclic 3-membered-ring compound and a polymer are mixed in the presence of at least one solvent and then the solvent is removed, or
b) at least one polymer, preferably a thermoplastic polymer, at least one iodine-containing compound and at least one heterocyclic 3-membered-ring compound are extruded, optionally with use of further auxiliaries, or
c) an aqueous dispersion of a preferably finely divided polymer, in the presence of an O/W emulsion, comprising at least one iodine-containing compound, at least one heterocyclic 3-membered-ring compound, water and organic solvent, is sheared, preferably by means of a paddle blade stirrer or a bead mill, or
d) an aqueous dispersion of a preferably finely divided polymer comprising at least one iodine-containing compound, in the presence of an O/W emulsion, comprising at least one heterocyclic 3-membered-ring compound, water and organic solvent, is sheared, preferably by means of a paddle blade stirrer or a bead mill, or
e) an aqueous dispersion of a preferably finely divided polymer, comprising at least one heterocyclic 3-membered-ring compound, in the presence of an O/W emulsion, comprising at least one iodine-containing compound, water and organic solvent, is sheared, preferably by means of a paddle blade stirrer or a bead mill, or
f) the polymer is prepared in the presence of at least one iodine-containing compound and at least one heterocyclic 3-membered-ring compound, preferably by emulsion polymerization of ethylenically unsaturated monomers.

10. Polymer preparation comprising at least one polymer according to claim 1 and at least one auxiliary.

11. Polymer characterized in that it is constructed of ethylenically unsaturated monomers M comprising:
at least 30% by weight, more particularly at least 40% by weight, very preferably at least 50% by weight, based on the total amount of the monomers M, of at least one neutral, monoethylenically unsaturated monomer M¹ having a water solubility of not more than 50 g/l at 25° C., preferably not more than 30 g/l at 25° C.,
up to 60% by weight, more particularly from 0.01 to 50% by weight, based on the total amount of the monomers M, of one or more polyethylenically unsaturated monomers M², different from the monomers M³, and
up to 40% by weight, more particularly up to 0.01% to 40% by weight, based on the total amount of the monomers M, of one or more monomers M³ which are different from the monomers M¹ and M² and are charge-carrying or potentially charge-carrying or neutral and preferably not potentially charge-carrying, having a water solubility of more than 50 g/l at 25° C.,
comprising at least one aziridine compound.

12. Use of polymers according to claim 11 for stabilizing iodine-containing compounds.

13. Composition comprising
a) at least one polymer according to claim 11 and
b) at least one iodine-containing compound.

14. Binder formulation comprising
at least one binder,
at least one polymer according to claim 7 or
at least one iodine-containing compound and at least one polymer according to claim 11.

15. Binder formulation according to claim 14, comprising at least one oxidatively drying binder.

16. Binder formulation according to claim 14, comprising at least one transition metal dryer.

17. Binder formulation according to claim 14, comprising

| | |
|---|---|
| 1% to 80% by weight | of alkyd resin binder(s), |
| 0% to 50% by weight | of colour pigments, |
| 2% to 97% by weight | of solvent(s), |
| 0.001% to 3% by weight | of a transition metal dryer, |
| 0.01 to 5% by weight | of a polymer according to Claim 1 or |
| 0.001% to 5% by weight | of an iodine-containing compound and 0.001% |
| | to 5% by weight of a polymer according to |
| | Claim 11. |

18. Use of the composition according to claim 1 or 13 for protecting industrial materials against destruction or infestation by microorganisms.

19. Industrial materials comprising at least one polymer according to claim 1 or composition according to claim 13.
